(19) United States
(12) Patent Application Publication
(10) Pub. No.: US 2026/0215599 A1
(43) Pub. Date: Jul. 30, 2026

(54) SHOE CARE APPARATUS

(71) Applicant: LG ELECTRONICS INC., Seoul (KR)

(72) Inventors: Chang Kyu KIM, Seoul (KR); Seok Hyun BAN, Seoul (KR); Ji Hun KIM, Seoul (KR)

(73) Assignee: LG ELECTRONICS INC., Seoul (KR)

(21) Appl. No.: 18/721,029

(22) PCT Filed: Dec. 2, 2022
(86) PCT No.: PCT/KR2022/019487

§ 371 Date: Jun. 17, 2024

(30) Foreign Application Priority Data
Dec. 17, 2021 (KR) 10-2021-0181278
May 3, 2022 (KR) 10-2022-0055076

(51) Int. Cl. A47F 7/08; A47F 3/00; A47F 5/025; A47L 23/20

(52) U.S. Cl. CPC A47F 7/08; A47F 3/001; A47F 3/005; A47F 5/025; A47L 23/205

(57) ABSTRACT

A shoe care apparatus includes a main body, a moving body, an air-blowing part and a first lighting. The main body and the moving body form an accommodation space together. A shoe is accommodated in the accommodation space. The moving body includes a transparent window. The air-blowing part circulates the air of the accommodation space. The first lighting is provided in the main body above the accommodation space. The first lighting illuminates the shoe placed on the bottom surface of the accommodation space. A path of an air flow channel is formed along the horizontal circumference of the first lighting.

### CROSS REFERENCE TO RELATED APPLICATIONS

This application is the National Phase of PCT International Application No. PCT/KR2022/019487, filed on Dec. 2, 2022, which claims priority under 35 U.S.C. 119(a) to Patent Application No. 10-2021-0181278, filed in the Republic of Korea on Dec. 17, 2021, and Patent Application No. 10-2022-0055076, filed in the Republic of Korea on May 3, 2022, all of which are hereby expressly incorporated by reference into the present application.

### TECHNICAL FIELD

The present invention relates to a shoe care apparatus, and more particularly, to a shoe care apparatus that manages and displays shoes stored therein.

### BACKGROUND ART

Only when shoes should be properly kept, the shoes can be worn for a long time without breaking the shape of the shoes. When the shoes are stacked in layers, the shape can be deformed. In general, a shoes cabinet is used for organization and keeping of the shoes.

In recent years, people who collect shoes of popular brands as part of hobby or financial tech have appeared, and a show case has been disclosed which is configured to keep and display the shoes.

US Patent Publication No. 2018-0127150 (hereinafter, referred to as ‘Prior Art Document 1’) entitled “Modular storage container”, discloses a modular storage container including a housing, a door panel, a fan, and a light source.

According to Prior Art Document 1 above, the housing has a rectangular parallelepiped box shape having an opening on a front surface thereof. The housing has an accommodation space therein. The door panel opens/closes the opening of the housing, and is configured to be transparent or translucent.

In Prior Art Document 1 above, the fan is installed on a rear panel of the housing. When the fan rotates, air in the accommodation space is ventilated to outside air. An air duct is formed in the housing for an air flow between the outside air and the accommodation space. The light source is installed in an upper panel and illuminates the accommodation space.

According to Prior Art Document 1 above, since internal air of the container is configured to be ventilated to the outside air, a possibility that an internal environment (temperature and humidity) of the container will be influenced by an external environment (temperature and humidity) of the container increases. That is, it may be difficult to control the internal temperature and humidity of the container.

For example, according to Prior Art Document I above, since the internal air of the container is just ventilated to the outside air, the humidity of the accommodation space can be continuously maintained when the humidity of the outside air is high like the rainy season. The air may change a color and a shape of the shoe stored in the container, and act to cause the shoe to be contaminated by mold and bacteria which are easy to breed at high temperature and humidity.

As such, in that Prior Art Document 1 above does not consider a technology of maintaining the internal temperature and humidity of the container in an optimal state, there is a risk of deformation or contamination of the shoe in the process of using the container by a user.

Further, according to Prior Art Document 1 above, the inside of the container can be viewed only through a door panel, and the inside of the container cannot be viewed at a left side or a right side of the container, so there is a limit in increasing a display effect of the shoe.

In relation to a technology of displaying the shoes for a commercial purpose, Korean Patent Unexamined Publication No. 2013-0034367(hereinafter, referred to as ‘Prior Art Document 2’) discloses a show case having transmissive display, and the resulting case is configured to include a show case body, a transparent display means, a turntable, a touch panel, and an LED.

The show case body has a space capable of storing products such as the shores therein. The transparent display means is installed on a front surface of the show case body. The products are seated on the turntable, and rotate inside the show-case body by the rotation of the turntable. The LED illuminates the products inside the show case body.

However, in that Prior Art Document 2 above does not consider a technology of controlling the internal temperature and humidity of the show case, there is a risk of deformation or contamination of the shoe in a state in which the show is stored inside the show case.

Further, according to Prior Art Document 2 above, the inside of the show case can be viewed only through the transparent display means, and the inside of the show case cannot be viewed at the left side or the right side of the show case, so there is a limit in increasing the display effect of the shoe.

Korean Patent Unexamined Publication No. 10-2000-0009653 (hereinafter, referred to as ‘Prior Art Document 3’) discloses a shoes cabinet for sanitization, and the resulting shoes cabinet is configured to include a body, an infrared radiation unit, a circulation fan, an air circulation passage, a sanitization filter unit, etc.

Prior Art Document 3 above discloses that the shoes are dehumidified, sanitized, and deodorized by far infrared rays and filters while storing the shoes.

However, according to Prior Art Document 3 above, the shoes cannot be displayed.

As described above, conventional devices that accommodate the shoes therein have a limit in the care of the shoes and the display of the shoes.

As a result, in the development of a shoe care apparatus, considering whether the display effect of the shoes can be maximized while constantly maintaining an environment of an internal space (hereinafter, referred to as ‘accommodation space’) of the shoe care apparatus, whether the accommodation space can be easily opened and closed, whether the shoes can be effectively stored and withdrawn in a state in which the accommodation space is opened, whether structural stability of the shoe care apparatus can be ensured in a state in which the accommodation space is maximally opened, etc., is required.

Moreover, it should be considered whether structural rigidity of a lowest shoe care apparatus can be maintained for a long period even though the shoe care apparatuses are stacked in multiple layers, whether electrical stability can be effectively guaranteed even though the shoe care apparatus is used for a long period, whether an interior effect by the shoe care apparatus can be maximized in addition to the display effect of the shoe, whether internal components are appropriately arranged in a limited space, whether use convenience is excellent, etc., should also be considered, and the development of the shoe care apparatus considering all of the points is required.

### DISCLOSURE

### Technical Problem

An objective to be achieved by the present invention is to provide a shoe care apparatus that achieves both a shoe display effect of displaying a shoe and a shoe care effect of preventing the deformation or contamination of the shoe, and in which a light for illuminating the shoe and an air flow channel serving as an air circulation path form a compact arrangement structure above an accommodation space.

An objective to be achieved by the present invention is to provide a shoe care apparatus having a structure that can minimize the height of an upper body including a light and an air flow channel while allowing the air flow channel to form a circulation path for sufficient air in an upper body above an accommodation space.

An objective to be achieved by the present invention is to provide a shoe care apparatus wherein the temperature and/or humidity of an accommodation space for accommodating a shoe is capable of being managed and the thermal efficiency of a heating part configured to transfer heat to air in an air flow channel is excellent.

An objective to be achieved by the present invention is to provide a shoe care apparatus capable of forming a uniform air flow over the entire surface of a shoe placed on an upper surface, even when the direction in which the shoe is placed changes as a turntable rotates.

An objective to be achieved by the present invention is to provide a shoe care apparatus wherein the amount of heat energy in an air flow channel dissipated outside the air flow channel and accommodation space is minimized.

### Technical Solution

A shoe care apparatus as described herein may include a body, a moving body, a blowing part, and a first light.

The body and the moving body may together form an accommodation space. The accommodation space may accommodate a shoe therein.

The moving body may include a transparent window.

The blowing part may be configured to circulate air in the accommodation space.

The first light may be provided in the body above the accommodation space. The first light may be configured to illuminate a shoe placed on a bottom surface of the accommodation space.

A path of the air flow channel may be formed along a horizontal circumference of the first light.

A suction port and a discharge port of the air flow channel may be formed horizontally opposite each other with respect to the first light.

The moving body may include a base and a turntable.

The transparent window may be coupled to the base.

The turntable may be rotatably coupled to the base about a vertical axis. The turntable may form the bottom surface of the accommodation space together with the base.

The first light may emit light onto a top surface of the turntable on which the shoe is placed along an extension of the vertical axis.

The suction port and the discharge port may be spaced equidistance from the vertical axis.

The body may include an upper body. The upper body may form a top surface of the accommodation space. An upper space may be formed inside the upper body. Gas flow may be interrupted between the upper space and the accommodation space.

The air flow channel may be provided above the accommodation space, wherein gas flow between the air flow channel and the upper space is interrupted.

The shoe care apparatus of the present invention may include a heating part and a controller. The heating part may be configured to transfer thermal energy to air moving along the air flow channel.

The controller may be configured to control a temperature of the heating part.

The heating part may include a heating wire and a heat dissipation member.

The heating wire may be coupled to the heat dissipation member. The heat dissipation member may be formed to have a surface in contact with air moving along the air flow channel.

A spacing projection portion may be formed on the inner surface of the air flow channel. The spacing projection portion may separate the heat dissipation member from the inner surface of the air flow channel.

The heat dissipation member may include a first heat dissipation plate. The first heat dissipation plate may have a plurality of winding holes through which the heating wire is passed and wound.

The winding holes may be formed in a zigzag shape along a path direction of the air flow channel so as to increase thermal energy transferred from the heating wire to the air.

The upper body may include an upper bottom plate. The upper bottom plate may divide the accommodation space and the upper space. The upper bottom plate may form a bottom surface of the air flow channel.

The spacing projection portion formed on the upper bottom plate may be parallel to the path direction of the air flow channel.

The heat dissipation member may include a second heat dissipation plate.

The second heat dissipation plate may be parallel to the inner surface of the air flow channel. The second heat dissipation plate may be in contact with the spacing projection portion.

The upper body may include a first external cabinet. The first outer cabinet may separate the upper space from the outside.

A closed projection portion may be formed on a portion of the inner surface of the air flow channel close to the first external cabinet. The closed projection portion may be formed to surround an edge of the second heat dissipation plate.

The closed projection portion may isolate a space between the inner surface of the air flow channel and the second heat dissipation plate from the air flow channel.

The upper bottom plate may have the suction port and the discharge port.

The blowing part may be provided in the air flow channel.

A wall surface of the air flow channel may be spaced apart from the first external cabinet.

The upper bottom plate may have a main hole.

The first light may include a light source, an insertion housing, a mounting housing, and a lens.

A circular hole through which light from the light source passes may be formed in the insertion housing. The insertion housing may be inserted into the main hole.

The light source may be coupled to the mounting housing. The mounting housing may be coupled to the insertion housing.

The lens may close the circular hole such that gas flow between the accommodation space and the upper space is interrupted.

The top surface of the turntable may form a circular shape around the vertical axis.

The first light may emit light onto the top surface of the turntable on which the shoe is placed.

The body may include a lower body. The lower body may be positioned below the accommodation space.

The base may be coupled to the lower body and movable relative to the lower body so as to open and close the accommodation space.

The transparent window may include a first window, a second window, and a third window.

The first window may form a front surface of the accommodation space.

The second window may form a left surface of the accommodation space.

The third window may form a right surface of the accommodation space.

### Advantageous Effects

In the shoe care apparatus according to an embodiment of the present invention, the air flow channel may be formed in the upper body. The suction port and the discharge port may be formed in the bottom surface of the upper body. The suction port and the discharge port of the air flow channel may be formed horizontally opposite each other with respect to the first light. Therefore, the height of the upper space may be formed low. Furthermore, efficient utilization of the upper space is possible, and the installability and usability of the shoe care apparatus may be increased.

In the shoe care apparatus according to an embodiment of the present invention, the suction port and the discharge port of the air flow channel may be formed horizontally opposite each other with respect to the first light, but spaced equidistant from the first light. Thus, in the accommodation space, an area in which air descends from the discharge port and an area in which air rises ending from the inlet may be divided based on a reference plane that is parallel to the forward/rearward direction and is a vertical plane, thereby facilitating air circulation in the accommodation space. Furthermore, even if the direction in which a shoe is placed changes as the turntable rotates, uniform air flow may be formed over the entire surface of the shoe placed on the upper surface of the turntable.

In the shoe care apparatus according to an embodiment of the present invention, the upper bottom plate may separate the accommodation space from the upper space. The suction port and the discharge port may be formed in the upper bottom plate. The air flow channel may be provided above the accommodation space, but gas flow between the air flow channel and the upper space may be interrupted. Therefore, the temperature of air circulating in the accommodation space and the air flow channel may be controlled regardless of the temperature change of outside air. Thus, the accommodation space may be maintained at an optimum temperature for proper shoe storage.

In the shoe care apparatus according to an embodiment of the present invention, the heating part may include a heating wire and a heat dissipation member. A measurement sensor that measures the temperature and/or humidity of the accommodation space may be installed at one side of the accommodation space. The controller may control a current applied to the heating wire based on a measurement value from the measurement sensor. Therefore, the temperature and/or humidity of the accommodation space may be controlled, and thus deformation or contamination of a shoe may be completely prevented.

In the shoe care apparatus according to an embodiment of the present invention, the heating wires may by formed in a zigzag shape along the path direction of the air flow channel. Thus, the heating wires may be spaced apart from each other in a transverse direction and/or a longitudinal direction with respect to the path direction of the air flow channel. Thus, thermal energy transferred directly from the heating wires to air may be increased. Thus, even when the controller supplies a relatively low current to the heating wires, more thermal energy may be transferred to air flowing in the accommodation space. Therefore, the amount of current required for operation of the shoe care apparatus may be reduced.

In the shoe care apparatus according to an embodiment of the present invention, the spacing projection portion may be formed on the inner surface of the air flow channel. The spacing projection portion may protrude from the inner surface of the air flow channel. The heating part may be spaced apart from the inner surface of the air flow channel by the spacing projection portion. Thus, the amount of thermal energy of the air flow channel dissipated by heat transfer through a flow channel wall and a flow channel cover may be reduced, thereby improving the operation efficiency of the heating part.

In the shoe care apparatus according to an embodiment of the present invention, the upper body may include the first external cabinet configured to separate the upper space from the outside. An isolation projection portion may be formed on a portion of the inner surface of the air flow channel close to the first external cabinet. The isolation projection portion may be formed on the top surface of the air flow channel. The isolation projection portion may surround the upper edge of the heating part. Thus, the isolation projection portion may form a space isolated from the air flow channel and the upper space. Thus, thermal energy of the air flow channel transferred to the flow channel cover may be reduced. Thus, even when the upward/downward separation distance between the air flow channel and the first external cabinet is reduced, the amount of thermal energy of the air flow channel dissipated to outside air by heat transfer may be minimized, thereby improving the operation efficiency of the heating part.

### DESCRIPTION OF DRAWINGS

FIG. 1a is a perspective view illustrating a shoe care apparatus according to an embodiment of the present invention.

FIG. 1b is a perspective view illustrating a state in which a shoe is stored in an accommodation space of the shoe care apparatus of FIG. 1a.

FIG. 2a is a perspective view illustrating a state in which the accommodation space of the shoe care apparatus of FIG. 1a is opened.

FIG. 2b is a perspective view illustrating a view of the shoe care apparatus of FIG. 2a viewed in another direction.

FIG. 3a is a side view illustrating a use state of the shoe care apparatus of FIG. 1b.

FIG. 3b is a front view illustrating the use state of the shoe care apparatus of FIG. 1b.

FIG. 4a as a cross-sectional view illustrating a body according to an embodiment of the present invention is a diagram an upper body viewed from the top.

FIG. 4b as a cross-sectional view illustrating the body according to an embodiment of the present invention is a diagram illustrating an upper body from the bottom.

FIG. 5a is a perspective view illustrating the body of the shoe care apparatus according to an embodiment of the present invention.

FIG. 5b is a perspective view illustrating a view of the body of FIG. 5a viewed in another direction.

FIG. 6 is a front view illustrating the body of FIG. 5a.

FIG. 7a is a perspective view illustrating a state in which a first external cabinet is separated from the body of the shoe care apparatus of FIG. 1a.

FIG. 7b is a plan view illustrating a state in which the first external cabinet is removed from the body of the shoe care apparatus of FIG. 1a.

FIG. 8a is a perspective cross-sectional view of the shoe care apparatus of FIG. 3a taken along line A-A. FIG. 8 does not illustrate the shoe.

FIG. 9 is an exploded perspective view of the first light of the shoe care apparatus of FIG. 7b.

FIG. 10 is an exploded perspective view of the second light of the shoe care apparatus of FIG. 7b.

FIG. 11a is a cross-sectional view of the shoe care apparatus of FIG. 3b taken along line C-C.

FIG. 11b is a cross-sectional view of the shoe care apparatus of FIG. 3a taken along line A-A.

FIG. 12a is a perspective view illustrating a state in which the image sheet is inserted into the insertion space of the internal panel.

FIG. 12b is a perspective view illustrating a state in which the image sheet is withdrawn from the insertion space of the internal panel.

FIG. 12c is an exploded perspective view of the internal panel of FIG. 12b.

FIG. 13 is a perspective view illustrating a state in which the first external cabinet and the second external cabinet are separated from the body of the shoe care apparatus of FIG. 1a.

FIG. 14a as a perspective view illustrating the opened state of the accommodation space of the shoe care apparatus of FIG. 1a is a diagram illustrating a state in which the internal panel moves through the second gap.

FIG. 14b is a partial cross-sectional view of the shoe care apparatus of FIG. 14a.

FIG. 15a as a perspective view illustrating the opened state of the accommodation space of the shoe care apparatus of FIG. 1a is a diagram illustrating a state in which the lower portion of the internal panel is inserted into the fixation groove.

FIG. 15b is a partial cross-sectional view of the shoe care apparatus of FIG. 15a.

FIG. 16a as a perspective view illustrating the opened state of the accommodation space of the shoe care apparatus of FIG. 1a is a diagram illustrating a state in which the internal panel is coupled to the middle body.

FIG. 16b is a partial cross-sectional view of the shoe care apparatus of FIG. 16a.

FIG. 17 as a partial cross-sectional view of the shoe care apparatus of FIG. 1a is a diagram illustrating a state in which the first fastening portion and the second fastening portion form a coupling force to each other.

FIG. 18a is a perspective view illustrating a state in which the first external cabinet is removed from the body of the shoe care apparatus of FIG. 1a. FIG. 18a illustrates a state in which a path cover of the air path is separated.

FIG. 18b is a cross-sectional view of the shoe care apparatus of FIG. 3a taken along line B-B.

FIG. 19a is a cross-sectional view of the shoe care apparatus of FIG. 3b taken along line C-C. FIG. 19a illustrates an air flow in the accommodation space while the front side of the shoe faces the front side in the first direction.

FIG. 19a is a cross-sectional view of the shoe care apparatus of FIG. 3b taken along line C-C. FIG. 19b illustrates the air flow in the accommodation space while the front side of the shoe faces the rear side in the second direction.

FIG. 20 is a perspective view illustrating the heating part of the shoe care apparatus of FIG. 18a.

FIG. 21 is a perspective cross-sectional view of the shoe care apparatus of FIG. 3a taken along line A-A. FIG. 21 does not illustrate the shoe.

FIG. 22a is a perspective cross-sectional view of the air path of the shoe care apparatus of FIG. 21 taken along line D-D.

FIG. 22b as a partial enlarged diagram of the shoe care apparatus of FIG. 21 is a diagram illustrating the air path and the heating part.

### MODES FOR THE INVENTION

Hereinafter, embodiments disclosed in this specification will be described in detail with reference to the accompanying drawings and the same or similar components are denoted by the same or similar reference numerals, and duplicated description thereof will be omitted. Suffixes “module” and “unit” for components used in the following description are given or mixed in consideration of easy preparation of the present invention only and do not have their own distinguished meanings or roles. Further, in describing the embodiment disclosed in this specification, a detailed description of related known technologies will be omitted if it is determined that the detailed description makes the gist of the embodiment disclosed in this specification unclear. Further, it is to be understood that the accompanying figures are just used for easily understanding the embodiments disclosed in this specification and a technical spirit disclosed in this specification is not limited by the accompanying figures and all changes, equivalents, or substitutes included in the spirit and the technical scope of the present invention are included.

Terms including an ordinary number, such as first and second, are used for describing various elements, but the elements are not limited by the terms. The terms are used only to discriminate one element from another element.

It should be understood that, when it is described that a component is “connected to” or “accesses” another component, the component may be directly connected to or access the other component or a third component may be present therebetween. In contrast, when it is described that a component is “directly connected to” or “directly accesses” another component, it is understood that no element is present between the element and another element.

A singular form includes a plural form if there is no clearly opposite meaning in the context.

In the present application, it should be understood that term “include” or “have”indicates that a feature, a number, a step, an operation, a component, a part or the combination thereof described in the specification is present, but does not exclude a possibility of presence or addition of one or more other features, numbers, steps, operations, components, parts or combinations thereof, in advance.

When the shoe is directly exposed to dust, water, heat, and/or sunshine, a fiber material of the shoe may be damaged over time, and a color and a form of the shoe may be changed.

In order to keep the shoe in an original state (e.g., a state of the shoe at the time of purchase or a state of a clean shoe) for a long time, the shoe should not be exposed much to light and the shoe should be kept at a place that is not too cold or hot. Further, the shoe needs to be kept at a place at which a temperature and a humidity are appropriately maintained.

Since the shoe made of a leather or suede material is easily colored or has mold, the shoe should be kept in an environment where temperature and humidity are appropriately maintained. A mothball acquired by solidifying pesticides and fragrances have a unique chemical smell that makes it difficult to remove because the smell permeates the shoe when the mothball is kept jointly with the shoe.

Further, when the shoes are stacked in layers, the form of the shoe may be changed by an applied load.

Meanwhile, as described above, in recent years, users who collect shoes of popular brands as part of a hobby or financial tech has increased, and the care of the shoe and the display of the shoe has become important needs of users.

Considering the points, a shoe care apparatus according to an embodiment of the present invention is configured to safely keep the shoe, establish and adjust an environment (e.g., a predetermined range of temperature, humidity, etc.) required for each shoe, and effectively display the shoe, and increase use convenience of the user.

A first direction X, a second direction Y, and a third direction Z described in the embodiment of the present invention may be directions orthogonal to each other.

The first direction X and the second direction Y may be directions parallel to a horizontal direction, and the third direction Z may be a direction parallel to a vertical direction. When the first direction X is a direction parallel to the front and rear direction, the second direction Y may be a direction parallel to a left and right direction.

In describing embodiments of the present invention, except for a case which is particularly differently limited, the first direction X, the second direction Y, and the third direction Z may be appreciated as a front direction, a left direction, and an upper direction, respectively.

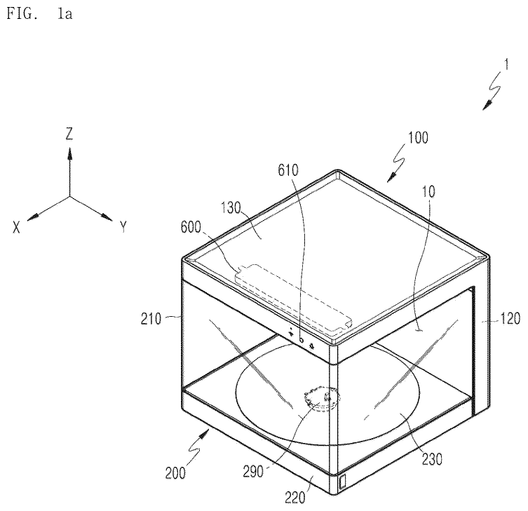

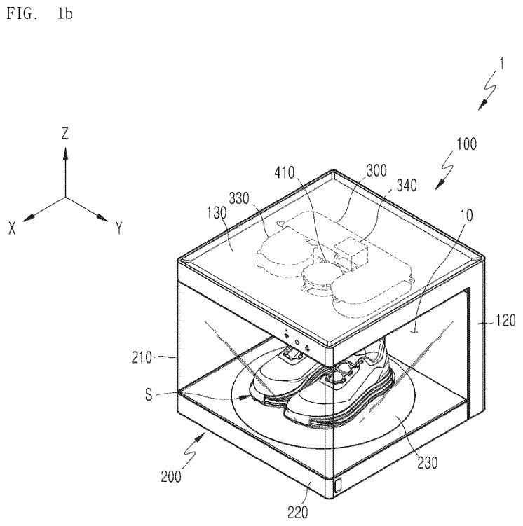

FIG. 1a is a perspective view illustrating a shoe care apparatus 1 according to an embodiment of the present invention. FIG. 1a illustrates a state in which an internal space (hereinafter, referred to as ‘accommodation space 10’) of the shoe care apparatus 1 is closed. FIG. 1b is a perspective view illustrating a state in which a shoe S is stored in the accommodation space 10 of the shoe care apparatus 1 of FIG. 1a.

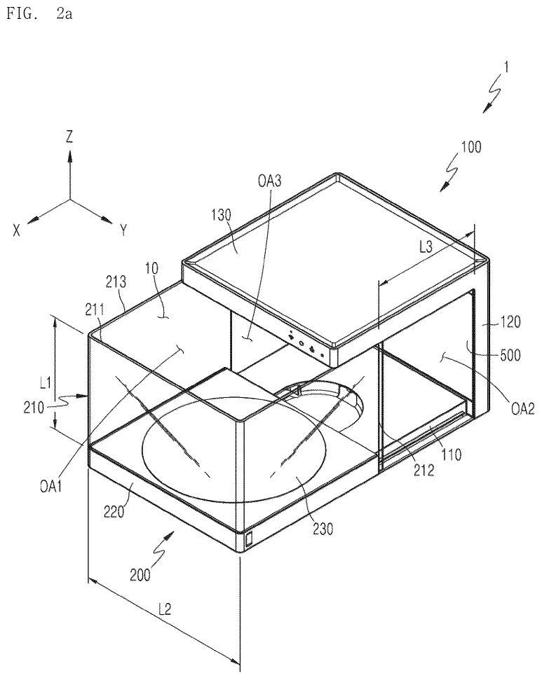

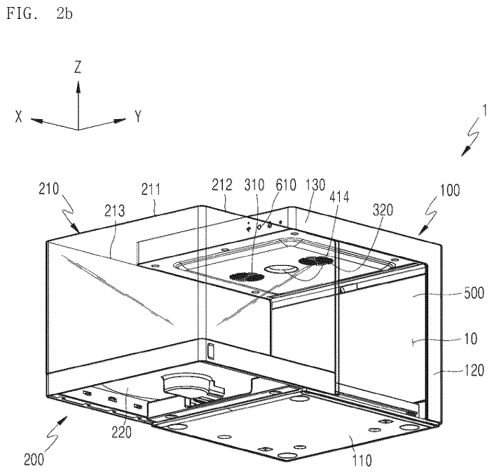

FIG. 2a is a perspective view illustrating a state in which the accommodation space 10 of the shoe care apparatus 1 of FIG. 1a is opened. FIG. 2b is a perspective view illustrating a view of the shoe care apparatus of FIG. 2a viewed in another direction.

As illustrated in FIGS. 1a and 1b, the shoe care apparatus 1 according to the embodiment is configured to include a body 100 and a moving body 200.

The body 100 and the moving body 200 form the accommodation space 10 accommodating the shoe S jointly. The body 100 and the moving body 200 are coupled to move with respect to each other. The moving body 200 may be coupled to the body 100 to reciprocally move in a horizontal direction.

The shoe care apparatus 1 illustrated in FIG. 1a may be changed like the shoe care apparatus 1 illustrated in FIG. 2a. That is, the moving body 200 may slidably move in a first direction X with respect to the body 100, and the shoe care apparatus 1 is transformed from the closed state to the opened state, and the accommodation space 10 may be opened.

The shoe care apparatus 1 illustrated in FIG. 2a may be changed like the shoe care apparatus 1 illustrated in FIG. 1a again. That is, the moving body 200 may slidably move in an opposite direction to the first direction X with respect to the body 100, and the shoe care apparatus 1 is transformed from the opened state to the closed state, and the accommodation space 10 may be closed.

As such, in the shoe care apparatus 1 according to the embodiment of the present invention, the moving body 200 may move the first direction X or the opposite direction to the first direction X with respect to the body 100, and reciprocally move in front and rear directions.

In the state in which the accommodation space 10 is closed, the accommodation space 10 may be sealed from outside air. Therefore, when the shoe S is accommodated in the accommodation space 10 and the accommodation space 10 is closed, a contact of the shoe S with dust and moisture of the outside air may be interrupted.

The body 100 may form an upper surface and a rear surface of the accommodation space 10.

The moving body 200 may form a front surface, a lower surface, and both side surfaces of the accommodation space 10.

The accommodation space 10 may be formed in a hexahedral form. However, the accommodation space 10 of the shoe care apparatus 1 according to the embodiment of the present invention is not limited to such a shape, and may be configured in various three-dimensional shapes.

The body 100 and the moving body 200 may form an overall appearance of the shoe care apparatus 1. An exterior of the shoe care apparatus 1 may be configured in the hexahedral form. That is, in the state in which the body 100 and the moving body 200 are coupled to each other and the accommodation space 10 is closed, the external appearance of the shoe care apparatus 1 may be configured in the hexahedral form. However, the shoe care apparatus I according to the embodiment of the present invention is not limited to such a shape, and may be configured in various three-dimensional shapes.

The body 100 may include an upper body 130, a middle body 120, and a lower body 110.

The upper body 130 is positioned at an upper side of the accommodation space 10. The upper body 130 forms the upper surface of the accommodation space 10. The upper body 130 may form an uppermost portion of the shoe care apparatus 1. The upper surface of the upper body 130 may form a flat surface along a substantially horizontal surface. When a plurality of shoe care apparatuses 1 is provided, any one shoe care apparatus 1 may be placed on the upper surface of the upper body 130 of the other one shoe care apparatus 1, and the shoe care apparatuses 1 may be stacked on each other.

The lower body 110 is positioned below the accommodation space 10. The lower body 110 may form a lowermost portion of the shoe care apparatus 1. The lower body 110 may form a bottom portion of the shoe care apparatus 1.

The middle body 120 is positioned behind the accommodation space 10. The middle body 120 forms the rear surface of the accommodation space 10. The middle body 120 may connect the upper body 130 and the lower body 110 behind the accommodation space 10. The middle body 120 may form a rear wall surface of the shoe care apparatus 1.

The body 100 is configured to include the upper body 130, the middle body 120, and the lower body 110, and as a result, the body 100 may form a substantially ‘C’ form on the side view.

As described above, the moving body 200 is configured to move forward and backward with respect to the body 100. The moving body 200 may include a base 220, a transparent window 210, and a turntable 230.

The base 220 may be coupled to the lower body 110 to be slidably movable in the first direction X. The base 220 may form the bottom portion of the moving body 200. The base 220 may be positioned at the upper side of the lower body 110. A bottom surface of the base 220 may be positioned in close contact with or in proximity to the upper surface of the lower body 110.

The transparent window 210 may form of extending upward from the base 220. The transparent window 210 may form the front surface, and both side surfaces (a left surface and a right surface) of the accommodation space 10. The transparent window 210 may be made of a transparent or translucent material.

Light inside and outside the accommodation space 10 may pass through the transparent window 210. The transparent window 210 may be made of a material which is weather-resistant to prevent discoloration. The transparent window 210 may be made of an acrylic (PMMA) material which is weather-resistant and scratch-resistant.

The transparent window 210 may prevent a beam having a predetermined wavelength from being introduced into the accommodation space 10. As an example, the transparent window 210 may be configured to block ultraviolet rays. The ultraviolet rays as an electromagnetic wave in which a wavelength corresponds to 10 to 397 nm shorter than visible rays are light which has a strong chemical action and causes getting sunburn or discoloration.

As an example, an ultraviolet-proof film may be attached to an inner surface or an outer surface of the transparent window 210. Alternatively, the inner surface or the outer surface of the transparent window 210 may be UV-coated with an ultraviolet-proof agent.

The transparent window 210 includes a first window 211, a second window 212, and a third window 213. The first window 211 may form the front surface of the accommodation space 10. The second window 212 may form the left surface of the accommodation space 10. The third window 213 may form the right surface of the accommodation space 10.

In the state in which the shoe S is accommodated in the accommodation space 10, a user may view the shoe S through the transparent window 210. As a result, the shoe care apparatus 1 may be used as a device which may display the shoe S while keeping and caring the shoe S.

As illustrated in FIGS. 1a and 1b, in the state in which the moving body 200 is positioned relatively at a rearmost side, the accommodation space 10 may be sealed from the outside air. In this case, the accommodation space 10 may be formed in the hexahedral form. In this case, the moving body 200 may be present at a first location and the shoe care apparatus 1 is in the closed state.

As illustrated in FIGS. 2a and 2b, in the state in which the moving body 200 moves in the first direction X, the accommodation space 10 may be opened. In this case, an upper portion of the first window 211 is spaced to a front side in the first direction X from the front surface of the upper body 130 to form a gap (hereinafter, referred to as ‘first gap’).

In this case, an upper portion of the first window 212 is spaced to a front side in the first direction X from the front surface of the upper body 120 to form a gap (hereinafter, referred to as ‘first gap’). The third window 213 is spaced to the front side in the first direction X from a right side surface of the middle body 120 to form a gap (hereinafter, referred to as ‘third gap’).

In the state in which the moving body 200 moves in the first direction X as much as possible, i.e., in the state in which the moving body 200 is positioned relatively at a frontmost side, the moving body 200 may be present at a second location and the shoe care apparatus 1 may be in the opened state.

The user may put the shoe S into the accommodation space 10 or withdraw the shoe S from the accommodation space 10 through the first gap. The user may put the shoe S into the accommodation space 10 or withdraw the shoe S from the accommodation space 10 through the first gap. An internal panel 500 may be coupled to the inner surface of the middle body 120 or uncoupled from the inner surface of the middle body 120.

The turntable 230 may form the upper surface on which the shoe S is placed. The upper surface of the turntable 230 may have a circular shape. The turntable 220 may form the lower surface of the accommodation space 10 jointly with the base 220.

The turntable 230 may be rotatably coupled to the base 220 around a vertical axis, i.e., an axis parallel to a third direction Z.

For the rotation of the turntable 230, a motor 290 may be provided in the moving body 200. The motor 290 may be coupled to the base 220. The turntable 230 may rotate in conjunction with the rotation of the motor 290. Rotational force of the motor 290 may be delivered to the turntable 230 through a reducer. The motor 290 may rotate unidirectionally or reciprocally rotate bidirectionally.

The turntable 230 is provided, and as a result, the shoe S may rotate in the accommodation space 10 or a display effect of the shoe S may be enhanced.

The shoe care apparatus 1 may include an operating button 610 and a controller 600. The operating button 610 may be formed in the body 100. As an example, the operating button 610 may be formed on the front surface of the upper body 130. When the user manipulates the operating button 610, the turntable 230 may rotate or stop. The user manipulates the operating button 610 to adjust a rotational speed of the turntable 230. The user may input a rotation time of the turntable 230 into the controller 600 through the operating button 610.

The user manipulates the operating button 610 to rotate the turntable 230 at a predetermined angle. In the state in which the accommodation space 10 is opened, the user may place the shoe S on the upper surface of the turntable 230 by holding any one part (heel top, lining, tong, etc.) of the shoe S. Thereafter, the user manipulates the operating button 610 to rotate the turntable 230 at a predetermined angle.

As an example, the user manipulates the operating button 610 to rotate the turntable 230 at a predetermined angle so that a front and rear direction of the shoe S coincides with the first direction X. Alternatively, the user manipulates the operating button 610 to rotate the turntable 230 at a predetermined angle so that the front and rear direction of the shoe S form a predetermined angle with the first direction X.

Therefore, even though the user places the shoe S on the upper surface of the turntable 230 while gripping any one part of the shoe S, the shoe S may be placed (displaced) in a direction desired by the user.

A sensor (not illustrated) that senses movement of the moving body 200 may be provided in the body 100. When the accommodation space 10 is closed, the controller 600 may rotate the turntable 230 by a signal of the sensor.

A load sensor (not illustrated) may be provided in the base 220. The load sensor may automatically measure a load of the shoe S placed on the turntable 230. The rotational speed of the turntable 230 according to a measurement value of the load sensor may be set in the controller 600. Alternatively, the user may input the rotational speed of the turntable 230 according to the measurement value of the load sensor into the controller 600 through the operating button 610.

A camera (not illustrated) may be provided in the shoe care apparatus 1. The camera may automatically shoot the shoe S placed on the turntable 230. The controller 600 may recognize the shape, size, and/or type of the shoe S through a shooting image of the camera.

The rotational speed of the turntable 230 according to the shape, size, and/or type of the shoe S may be set in the controller 600. Alternatively, the user may input the rotational speed of the turntable 230 according to the shape, size, and/or type of the shoe S into the controller 600 through the operating button 610.

The shoe care apparatus 1 may include an operating sensor. The operating sensor may sense an access of the user. The turntable 230 may be rotated or stopped by the sensing signal of the operating sensor.

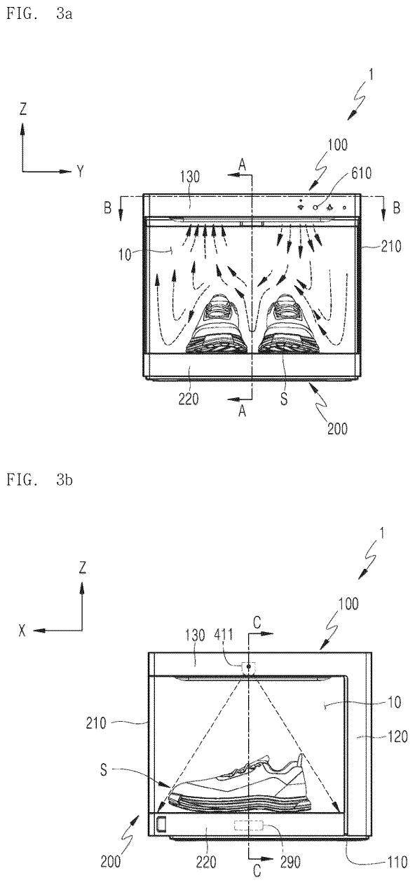

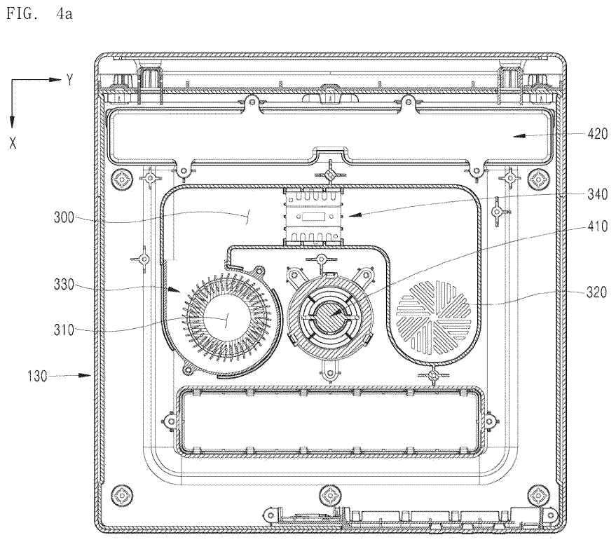

FIG. 3a is a side view illustrating a use state of the shoe care apparatus 1 of FIG. 1b. FIG. 3a illustrates a state of illuminating the shoe S in the accommodation space 10.

FIG. 3b is a front view illustrating the use state of the shoe care apparatus 1 of FIG. 1b. FIG. 3b illustrates an air flow in the accommodation space 10.

The shoe care apparatus 1 according to the embodiment of the present invention may include a first light 410. The first light 410 may be provided in the upper body 130.

As illustrated in FIG. 3a, the first light 410 may illuminate the accommodation space 10. The first light 410 may include a light source 411 and a lens 414.

The light source 411 may intensively irradiate light onto the upper surface of the turntable 230 on which the shoe S is placed. The light of the light source 411 may intensively illuminate the shoe S placed on the upper surface of the turntable 230. When the light 410 is turned, an image of the shoe S stored in the accommodation space 10 may be changed by the light of the light source 411.

The light of the light source 411 may illuminate the accommodation space 10 by passing through the lens 414. An ultraviolet-proof film may be attached to the lens 414 or the ultraviolet-proof agent may be coated on the lens 414 in order to block the ultraviolet rays.

When the user manipulates the operating button 610, the light source 411 may be turned on or off. The user may input an operating time of the light source 411 into the controller 600 through the operating button 610. The user manipulates the operating button 610 to adjust the operating time of the light source 411.

Alternatively, the light source 411 may be turned on or off by the sensing signal of the operating sensor. The controller 600 may turn on-off the light source by the signal of the operating sensor.

Alternatively, the light source 411 may be turned on or off by the sensing signal of the sensor. When the accommodation space 10 is closed, the controller 600 may turn on-off the light source by the signal of the sensor.

Alternatively, the operating time and the operating pattern of the light source according to the measurement value of the load sensor may be set in the controller 600. The user may input the operating time and the operating pattern of the light source 411 according to the measurement value of the load sensor into the controller 600 through the operating button 610.

Alternatively, the operating time and the operating pattern of the light source according to the shape, size, and/or type of the shoe S may be set in the controller 600. The user may input the operating time and the operating pattern of the light source 411 according to the shape, size, and/or type of the shoe S into the controller 600 through the operating button 610.

The light source 411 may be configured to change the color of the light. As an example, the light source 411 may be constituted by Red Green Blue White (RGBW) LEDs. The controller 600 may control current applied to a Red (R) LED, a Green (G) LED, a Blue (B) LED, and a White (W) LED. When the controller 600 controls the current applied to the RGBW LEDs, the aesthetics and a color sense of the shoe S stored in the accommodation space 10 may be variously changed. The user may input a pattern of the current applied to the RGBW LED into the controller 600 through the operating button 610.

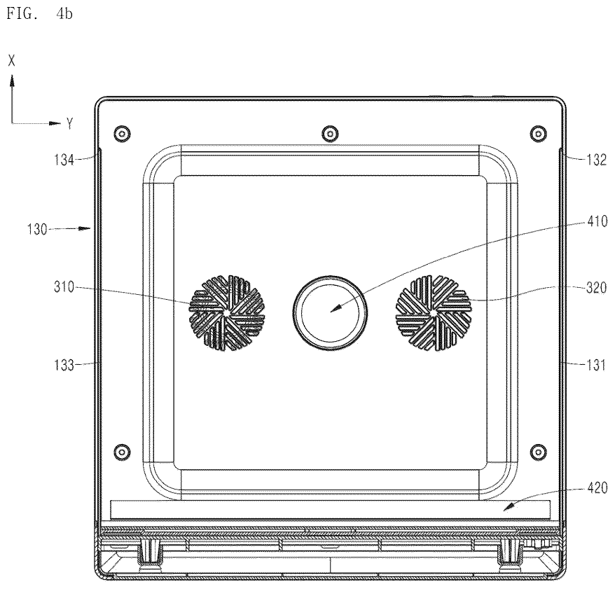

FIG. 4a as a cross-sectional view illustrating a body 100 according to an embodiment of the present invention is a diagram an upper body 130 viewed from the top. In FIG. 4a, in order to show an internal view of the upper body 130, a state in which a first external cabinet 136 of the upper body 130 is removed is illustrated.

FIG. 4b as a cross-sectional view illustrating the body 100 according to an embodiment of the present invention is a diagram illustrating the upper body 130 from the bottom.

The body 100 may be configured to include an air path 300. The body 100 may be configured to include a suction port 310 and a discharge port 320.

The air path 300 may be formed in the upper body 130. The air path 300 may be provided inside the upper body 130.

The air path 300 connects the suction port 310 and the discharge port 320. The suction port 310 may form an inlet of the air path 300, and the discharge port 320 may form an outlet of the air path 300.

The suction port 310 may be formed on a bottom surface of the upper body 130. The discharge port 320 may be formed on the bottom surface of the upper body 130.

The air in the accommodation space 10 may be suctioned into the air path 300 through the suction port 310. The air in the air path 300 may be discharged to the accommodation space 10 through the discharge port 320. Therefore, air forcibly blown by a blowing part 330 to be described below may be circulated in the accommodation space 10 and the air path 300.

As illustrated in FIGS. 1b and 4a, the shoe care apparatus 1 according to the embodiment of the present invention may include the blowing part 330 and a heating part 340. The blowing part 330 and the heating part 340 may be provided in the upper body 130.

The blowing part 330 is configured to circulate the air in the accommodation space 10.

The blowing part 330 may be positioned in the upper body 130. The blowing part 330 may be placed in the air path 300, and may generate a flow of the air in the air path 300.

The heating part 340 may be configured to directly or indirectly heat the air in the accommodation space 10. The heating part 340 may be placed in the body 100. The heating part 340 may be placed in the air path 300.

The body 100 may be configured to include the first light 410 and a second light 420. The first light 410 may be configured to be formed on the bottom surface of the upper body 130 and to illuminate the accommodation space 10. The second light 420 may be configured to be formed on the bottom surface of the upper body 130 and to illuminate the middle body 120 behind the first light 410.

The heating part 340 may deliver thermal energy to the air which moves in the air path 300. The heating part 340 may be configured to include a heat wire 341.

The blowing part 330 and the heating part 340 may control the temperature and/or humidity of the accommodation space 10.

When the user manipulates the operating button, the blowing part 330 may rotate or stop. The user manipulates the operating button to adjust the rotational speed of the blowing part 330. The user may input the rotation time of the blowing part 330 into the controller through the operating button. The air in the accommodation space 10 may be circulated by operating the blowing part 330, and the air in the accommodation space 10 may maintain a uniform state as a whole.

When the user manipulates the operating button, the heating part 340 may be turned on or off. The user manipulates the operating button to adjust the operating time of the heating part 340. The user may input an operating temperature of the heating part 340 into the controller through the operating button. The temperature of the air heated by the heating part 340 may be selected or adjusted according to characteristics of a used shoe S.

The blowing part 330 and the heating part 340 may be operated for a predetermined time. Further, each of the operating and the stopping of the blowing part 330 and the heating part 340 may be repeatedly conducted for a predetermined time. The time may be decided by the user, or automatically decided by a program.

According to the embodiment of the present invention, the temperature and/or the humidity of the accommodation space 10 may be maintained at an optimal state which is suitable for the characteristics of each shoe S.

Therefore, the shoe care apparatus 1 according to the embodiment of the present invention may achieve both a shoe display effect of displaying the shoe and a shoe care effect of interrupting deformation or contamination of the shoe.

The blowing part 330 and the heating part 340 may be turned on or off by the sensing signal of the sensor. When the accommodation space 10 is closed, the controller 600 may turn on-off the blowing part 330 and the heating part 340 by the signal of the sensor.

Alternatively, the operating time and the operating pattern of the blowing part 330 and the heating part 340 according to the measurement value of the load sensor may be set in the controller. The user may input the operating time and the operating pattern of the blowing part 330 and the heating part 340 according to the measurement value of the load sensor into the controller through the operating button.

Alternatively, the operating time and the operating pattern of the blowing part 330 and the heating part 340 according to the shape, size, and/.or type of the shoe may be set in the controller. The user may input the operating time and the operating pattern of the blowing part 330 and the heating part 340 according to the shape, size, and/.or type of the shoe into the controller through the operating button.

Therefore, the shoe care apparatus 1 according to the embodiment of the present invention controls the temperature and/or the humidity of the accommodation space 10 differently according to a material, a load, the shape, the size, and/or the type of the shoe to completely interrupt the deformation or the contamination of the shoe.

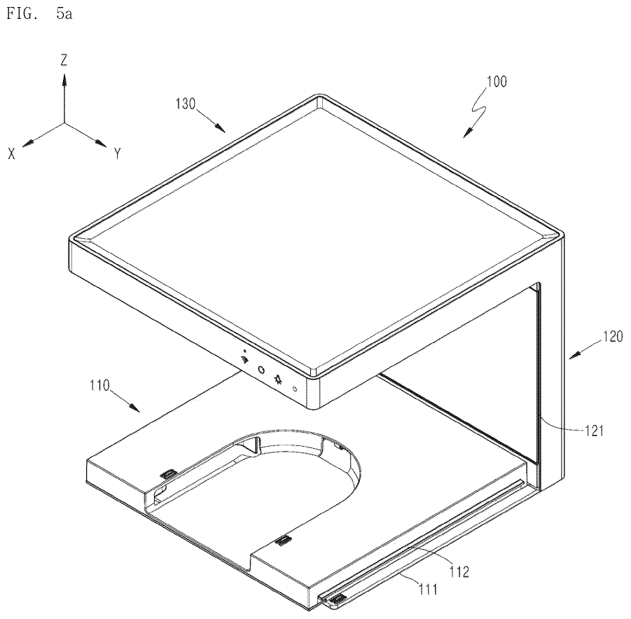

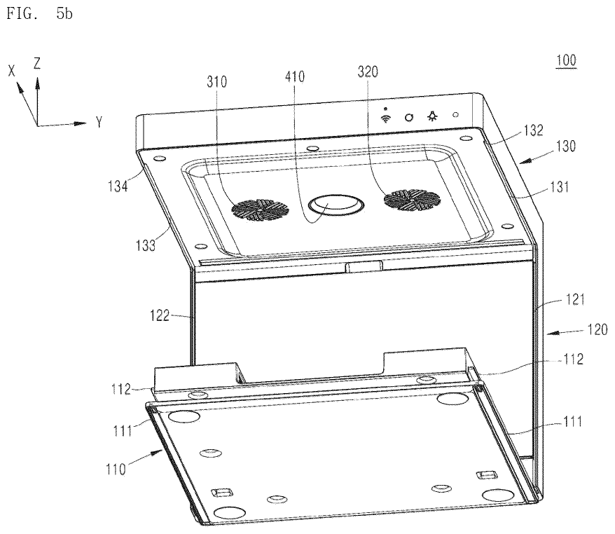

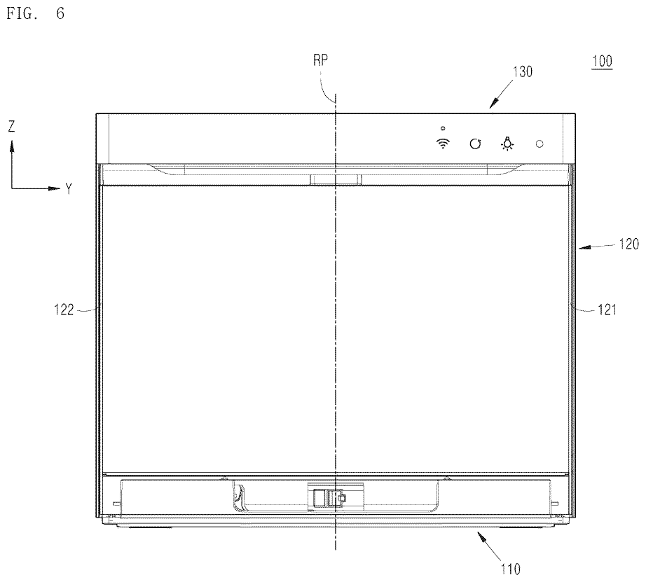

FIG. 5a is a perspective view illustrating the body 100 of the shoe care apparatus 1 according to the embodiment of the present invention. FIG. 5b is a perspective view illustrating a view of the body 100 of FIG. 5a viewed in another direction.

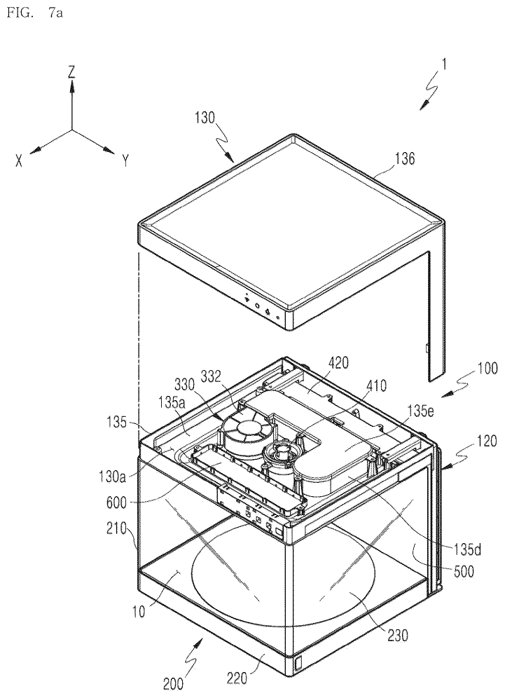

FIG. 6 is a front view illustrating the body 100 of FIG. 5a.

The lower body 100 of the body 100 forms the bottom surface of the shoe care apparatus 1. The lower body 110 may be configured to support the lower side of the moving body 200.

The middle body 120 of the body 100 extends upward from a rear side of the lower body 110 and forms a back surface of the shoe care apparatus 1. The inner surface of the middle body 120 forms the back surface of the accommodation space 10.

The upper body 130 of the body 100 extends forward from the upper side of the middle body 120 and forms the upper surface of the shoe care apparatus 1. The inner surface of the upper body 130 may forms the upper surface of the accommodation space 10. The upper body 130 may be configured to support the upper side of the moving body 200.

The body 100 may be configured in a symmetric form around a reference plane RP orthogonal to the second direction Y.

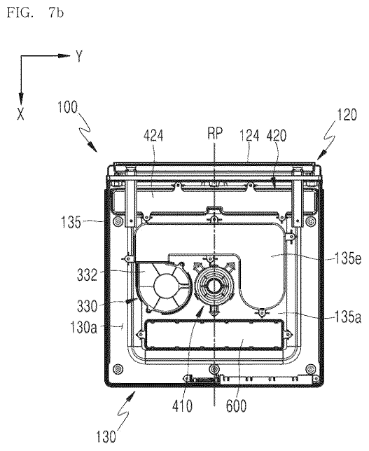

FIG. 7a is a perspective view illustrating a state in which a first external cabinet 136 is separated from the body 100 of the shoe care apparatus 1 of FIG. 1a.

FIG. 7b is a plan view illustrating a state in which the first external cabinet 136 is removed from the body 100 of the shoe care apparatus 1 of FIG. 1a.

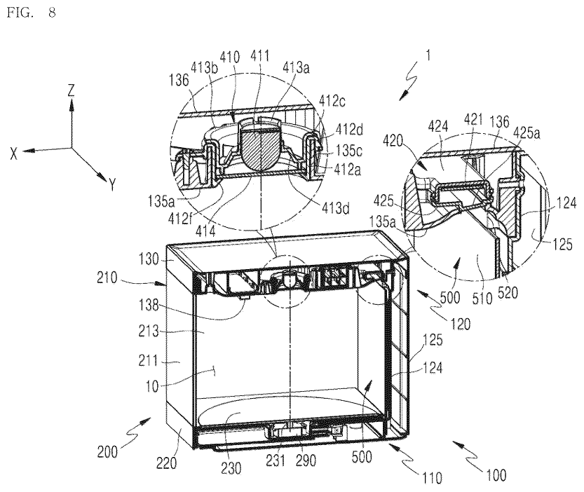

FIG. 8a is a perspective cross-sectional view of the shoe care apparatus 1 of FIG. 3a taken along line A-A. FIG. 8 does not illustrate the shoe S.

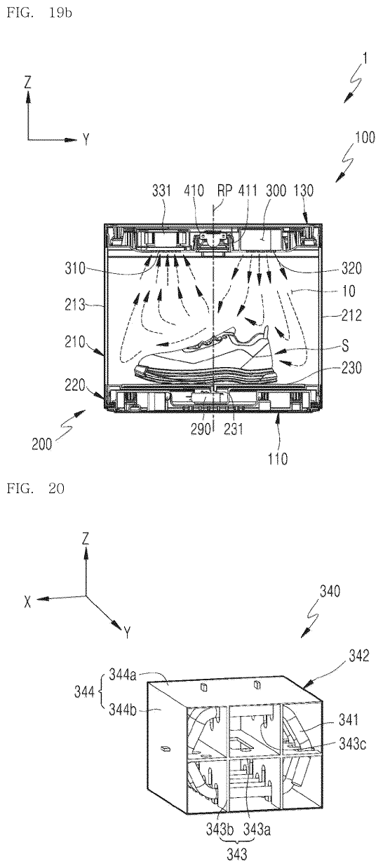

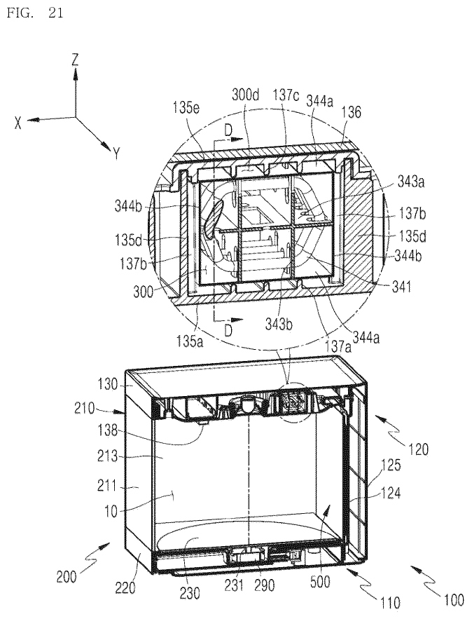

As illustrated in FIGS. 20a to 21, the shoe care apparatus 1 may include a body 100, a moving body 200, a blowing part 330, a first light 410, and a second light 420.

The body 100 and the moving body 200 may form the accommodation space 10 accommodating the shoe S jointly. The body 100 and the moving body 200 may be coupled to move with respect to each other. The moving body 200 may be coupled to the body 100 to reciprocally move in the front and rear direction.

The body 100 may include the upper body 130. The upper body 130 may be positioned above the accommodation space 10. The upper body 130 may have an upper space 130a of which gas flow is disconnected from the accommodation space therein. The upper space 130a may have a hexahedral shape in which lengths in the first direction X and the second direction Y are larger than a length in the third direction Z.

The upper body 130 may include a first internal cabinet 135 and a first external cabinet 136. The first internal cabinet 135 and the first external cabinet 136 may form the accommodation space 10 jointly.

As illustrated in FIG. 7a, the first internal cabinet 135 may have a rectangular box shape opened upward. The first internal cabinet 135 may have an air flow path 300 connected to the accommodation space 10. The first internal cabinet 135 may include an upper bottom plate 135a.

The upper bottom plate 135a may partition the accommodation space 10 and the upper space 130a. The lower surface of the upper bottom plate 135a may form the top of the accommodation space 10. The upper surface of the top bottom plate 135a may form the bottom of the upper space 130a. The upper bottom plate 135a may have a plate shape which is wide in the horizontal direction.

The blowing part 330 is a component that circulates air in the accommodation space 10. The blowing part 330 and the air flow path 300 may be provided on the upper surface of the upper bottom plate 135a.

The blowing part 330 may include a fan 331 and a fan housing 332. The fan 331 may pressure-feed the air by a rotary motion of an impeller. The fan housing 332 may constitute a part of the air flow path 300.

As illustrated in FIG. 7b, the suction port 310 and the discharge port 320 may be formed on the upper bottom plate 135a.

The air in the accommodation space 10 may be suctioned into the air flow path 300 through the suction port 310. The air in the air flow path 300 may be discharged to the accommodation space 10 through the discharge port 320. Therefore, air forcibly blown by the blowing part 330 may be circulated in the accommodation space 10 and the air path 300.

As illustrated in FIG. 8, the moving body 200 may include the transparent window 210, the base 220, and the turntable 230.

The body 100 may include the lower body 110. The lower body 110 may be positioned below the accommodation space 10.

The base 220 may be coupled to the lower body 110 to be relatively movable in the front and rear direction so as to open/close the accommodation space 10. The transparent window 210 may be coupled to the base 220. The transparent window 210 may form the front surface, and both side surfaces (a left surface and a right surface) of the accommodation space 10.

The turntable 230 may be rotatably coupled to the base 220 around a vertical axis 231. The base 220 and the turntable 230 may form the lower surface of the accommodation space 10 jointly. The upper surface of the turntable 230 may have the circular shape around the vertical axis 231.

The motor 290 may be provided in the base 220. The motor 290 may deliver the rotary movement to the turntable 230. The rotational axis 231 of the turntable 230 may be in line with the vertical direction.

The axis of the motor 290 may be directly coupled to the rotational axis 231 of the turntable 230. The vertical axis 231 may mean the rotational axis 231 of the turntable 230. An alternate long and short dash line illustrated in FIG. 8 may mean an extension line of the vertical axis 231.

A power supply (not illustrated) may be provided in the base 220. The power supply may supply power to the motor 290. The controller 600 may control the power supplied to the motor 290 from the power supply.

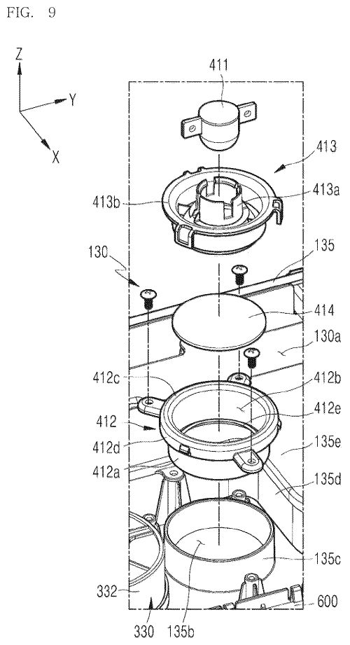

FIG. 9 is an exploded perspective view of the first light 410 of the shoe care apparatus 1 of FIG. 7b.

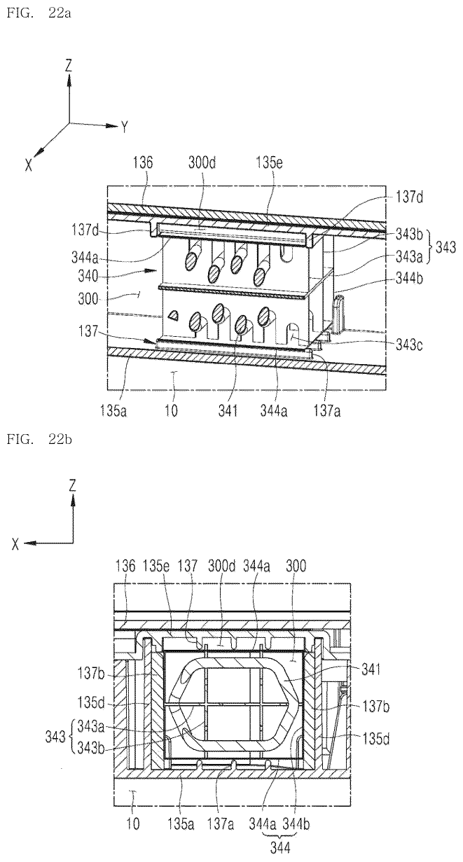

As illustrated in FIGS. 21 and 22, the first light 410 may irradiate light to the upper surface of the turntable 230 on which the shoe S is placed on the extension line of the vertical axis 231. The first light 410 may be coupled to the upper bottom plate 135a.

The first light 410 may include a light source 411, an insertion housing 412, a mounting housing 413, and a lens 414.

The light source 411 may irradiate the light to the accommodation space 10. A power supply (not illustrated) may be provided in the base 220. The power supply may supply the power to the light source 411. The controller 600 may control the power supplied to the light source 411 from the power supply.

The light source 411 may be provided on the extension line of the vertical axis 231. The accommodation space 10 may be parallel to the first direction X which is the horizontal direction and form a symmetry based on the reference surface RP which is a vertical surface. The extension line of the vertical axis 231 may be positioned within the reference plane RP.

The light of the light source 411 may illuminate the shoe S placed on the bottom of the accommodation space 10. When the light 410 is turned, an image of the shoe S stored in the accommodation space 10 may be changed by the light of the light source 411.

When the user manipulates the operating button 610, the light source 411 may be turned on or off. The user may input an operating time of the light source 411 into the controller 600 through the operating button 610. The user manipulates the operating button 610 to adjust the operating time of the light source 411.

The light source 411 may be provided as an LED. Both terminals of the light source 411 may be extended from light source 411 in the horizontal direction. Both terminals may be extended in opposite directions to each other.

The light source 411 may be formed by a white LED emitting white light. The light source 411 may illustrate the shoe S accommodation in the accommodation space 10. Therefore, in the state in which the light around the shoe care apparatus 1 is turned off or weak, the visibility of the shoe S stored in the accommodation space 10 may be enhanced. Therefore, the display effect of the shoe S stored in the accommodation space 10 may be enhanced.

Alternatively, the light source 411 may be configured to change the color of the light. As an example, the light source 411 may be formed by a Red Green Blue White (RGBW) LED. The controller 600 may control current applied to a Red (R) LED, a Green (G) LED, a Blue (B) LED, and a White (W) LED.

When the controller 600 controls the current applied to the RGBW LEDs, the aesthetics and a color sense of the shoe S stored in the accommodation space 10 may be variously changed. The user may input a pattern of the current applied to the RGBW LED into the controller 600 through the operating button 610.

A main hole 135b and a circular projection portion 135c may be formed on the upper bottom plate 135a. The circular projection portion 135c may be formed to extend upward at the edge of the main hole 135b. The main hole 135b may extend in the upper and lower direction by the inner surface of the circular projection portion 135c.

As illustrated in FIGS. 21 and 22, the insertion housing 412 may include an insertion sleeve 412a, a first insertion bending portion 412c, and a second insertion bending portion 412d.

The insertion sleeve 412a may have a circular pipe shape. The inner surface of the insertion sleeve 412a may form a circular hole 412b through which the light of the light source 411 passes. The insertion sleeve 412a may be inserted into the main hole 135b. The outer surface of the insertion sleeve 412a may be opposed to the inner surface of the circular projection portion 135c.

The first insertion bending portion 412c may be formed to extend outward on the outer surface of the insertion sleeve 412a. The first insertion bending portion 412c may be seated on the top of the circular projection portion 135c.

The second insertion bending portion 412d may be formed to extend downward from the first insertion bending portion 412c. An upper portion of the circular projection portion 135c may be inserted between the insertion sleeve 412a and the insertion bending portion. Therefore, a gas flow of the upper space 130a and the accommodation space 10 through the circular projection portion 135c and the insertion housing 412 may be stopped.

A step portion 412e may be formed on the inner surface of the insertion sleeve 412a in the circumferential direction. The step portion 412e may form a second reflection surface 412f that reflects the light of the light source 411, which penetrates the lens 414. The second reflection surface 412f may form an axial symmetry around the vertical axis 231. The second reflection surface 412f may reflect the light of the light source 411 to the accommodation space 10.

As illustrated in FIGS. 21 and 22, the mounting housing 413 may include a mounting sleeve 413a, a mounting bending portion 413b, and a closed projection portion 413c.

The light source 411 may be coupled to the mounting sleeve 413a. The light source 411 may be inserted into the inside of the mounting sleeve 413a. A plurality of grooves into which both terminals of the light source 411 are inserted downward may be formed in the mounting sleeve 413a. The grooves of the mounting sleeve 413a may be formed in opposite directions to each other around the vertical axis 231.

A diameter of an upper end portion of the mounting sleeve 413a may be smaller than the diameter of the light source 411. In the process in which the light source 411 is inserted into the inside of the mounting sleeve 413a, the mounting sleeve 413a may be bending-deformed outward. When both terminals of the light source 411 are completely inserted into the grooves of the mounting sleeve 413a, the mounting sleeve 413a may be elastically restored. A protrusion may be formed on the inner surface of the upper end portion of the mounting sleeve 413a. Therefore, the mounting sleeve 413a may prevent detachment of the light source 411.

The mounting sleeve 413a may be inserted into the inside of the insertion sleeve 412a. The outer surface of the mounting sleeve 413a may be opposed to the inner surface of the insertion sleeve 412a.

A lower portion of the mounting sleeve 413a may form a first reflection surface 413d that reflects the light of the light source 411 toward the lens 414. The first reflection surface 413d may form the axial symmetry around the vertical axis 231. The first reflection surface 413d may reflect the light of the light source 413 to the accommodation space 10.

The mounting bending portion 413b may be formed to extend outward on the outer surface of the mounting sleeve 413a. The mounting bending portion 413b may be seated on the top of the first insertion bending portion 412c.

A hook may be formed at any one of the mounting bending portion 413b and the second insertion bending portion 412d. In addition, a portion to which the hook is hooked may be formed at the other one of the mounting bending portion 413b and the second insertion bending portion 412d. Therefore, as the mounting bending portion 413b is seated on the top of the first insertion bending portion 412c, a coupling force may be formed between the insertion housing 412 and the mounting housing 413.

The closed projection portion 413c may extend downward on the lower end of the mounting sleeve 413a. The closed projection portion 413c may be formed around the vertical axis 231 in the circumferential direction.

The lens 414 may be inserted into the inside of the insertion sleeve 412a. The lens 414 may be mounted on the top of the step portion 412e. The top of the step portion 412e may form a contact surface with the lens 414 in the circumferential direction.

As the mounting sleeve 413a is inserted into the inside of the insertion sleeve 412a, the lens 414 may be in close contact with the bottom of the closed projection portion 413c. Therefore, the lens 414 may close the circular hole 412b. Therefore, the gas flow of the upper space 130a and the accommodation space 10 through the circular hole 412b may be stopped.

The light of the light source 411 may illuminate the accommodation space 10 by passing through the lens 414. An ultraviolet-proof film may be attached to the lens 414 or the ultraviolet-proof agent may be coated on the lens 414 in order to block the ultraviolet rays.

As illustrated in FIG. 8, the body 100 may include the middle body 120. The middle body 120 may form the rear surface of the accommodation space 10.

The internal panel 500 may be coupled to the front surface of the middle body 120 in the accommodation space 10. Therefore, the turntable 500 may form the rear surface of the accommodation space 10 jointly with the middle body 120. The internal panel 500 may be detachably coupled to the middle body 120. As an example, the internal panel 500 may be coupled to the front surface of the middle body 120 by a magnetic force.

The front surface of the middle body 120 may generally form the plane. The internal panel 500 may have the thin plate shape. The rear surface of the internal panel 500 may be in close contact with the front surface of the middle body 120. The front surface and/or the rear surface of the internal panel 500 may form a similar shape and a similar area to the front surface of the middle body 120.

Therefore, even though the internal panel 500 is coupled or not coupled to the middle body 120, the hexahedral shape and size of the accommodation space 10 may be maintained substantially constantly. Therefore, even though the internal panel 500 is coupled or not coupled to the middle body 120, the accommodation space 10 may show predetermined aesthetics based on the shape and the size.

The front surface of the internal panel 500 may be made of the same or similar material as the front surface of the middle body 120.

Therefore, even though the internal panel 500 is coupled or not coupled to the middle body 120, the light of the first light 410 and the second light 420 reflected on the rear surface of the accommodation space 10 may be delivered to a vision of a person who sees the shoe S to be the same or similar. Therefore, even though the internal panel 500 is coupled or not coupled to the middle body 120, the accommodation space 10 may show predetermined aesthetics based on the light.

The internal panel 500 may be configured to accommodate an image sheet 550. The image sheet 500 may mean a sheet including an image to the letter. As an example, the image sheet 550 may be a sheet printed with a photo, a picture, or a letter.

The internal panel 500 may form an insertion space 500c accommodating the image sheet 550. The internal panel 500 may include a transparent or translucent material so as to expose the image sheet 550 to the accommodation space 10.

The image sheet 550 may be exposed to the vision of the person who sees the shoe S accommodated in the shoe care apparatus 1. Therefore, the user of the shoe care apparatus 1 may display the photo and the picture on the rear surface of the accommodation space 10.

The insertion space 500c may be opened to the upper side. The image sheet 550 may be inserted into the insertion space 500c through an upper opening. The image sheet 550 inserted into the insertion space 500c may be withdrawn to the outside through the upper opening. Therefore, the user of the shoe care apparatus 1 may display various photos and pictures on the rear surface of the accommodation space 10.

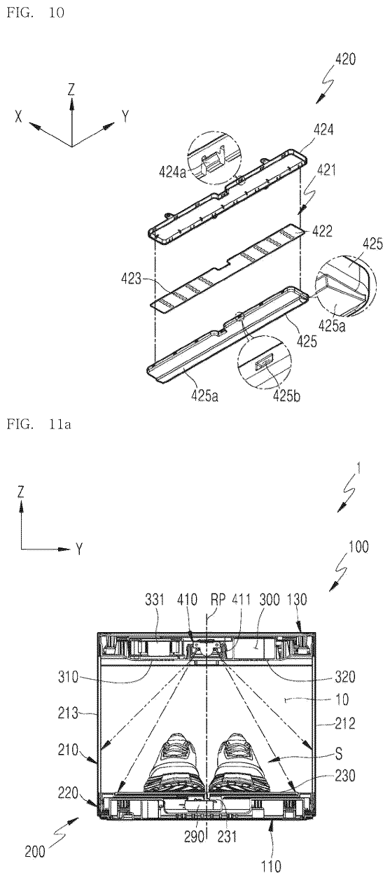

FIG. 10 is an exploded perspective view of the second light 420 of the shoe care apparatus 1 of FIG. 7b.

As illustrated in FIGS. 21 and 23, the second light 420 may illuminate the rear surface of the accommodation space 10. The second light 420 may be parallel to the first direction X which is the horizontal direction and form the symmetry based on the reference surface RP which is the vertical surface. The extension line of the vertical axis 231 may be positioned within the reference plane RP.

The second light 420 may include a light source module 421, a heat dissipation cover 424, and a transmission cover 425.

As illustrated in FIGS. 20b and 23, the light source module 421 may be formed to be long in the second direction Y. The light source module 421 may be formed by an LED module. The light source module 421 may include a module substrate 422 and a plurality of white LEDs.

A power supply (not illustrated) may be provided in the base 220. The power supply may supply power to the light source module 421. The controller 600 may control the power supplied to the light source module 421 from the power supply.

The module substrate 422 may be formed to be long in the second direction Y. The plurality of LEDs may be placed on the bottom of the module substrate 422 at a predetermined gap in the second direction Y. Therefore, light which the light source module 421 irradiates onto the rear surface of the accommodation space 10 may form a substantially constant illuminance in the second direction Y.

Therefore, the visibility of the rear surface of the accommodation space 10 is enhanced, and as a result, the display effect of the image sheet 550 accommodated in the internal panel 500 may be enhanced. In particular, in the state in which the light around the shoe care apparatus 1 is turned off or weak, the display effect of the image sheet 550 accommodated in the internal panel 500 may be enhanced.

Alternatively, the light source module 421 may be configured to change the color of the light. As an example, the light source module 421 may be constituted by the module substrate 422 and a plurality of Red Green Blue White (RGBW) LEDs. The controller 600 may control current applied to a Red (R) LED, a Green (G) LED, a Blue (B) LED, and a White (W) LED.

When the controller 600 controls the current applied to the RGBW LEDs, the aesthetics and the color sense of the rear surface of the accommodation space 10 may be variously changed. The user may input a pattern of the current applied to the RGBW LED 423 into the controller 600 through the operating button 610.

Meanwhile, a wavelength of the light of the second light 420 may vary depending on the temperature and/or the humidity of the accommodation space 10. Here, a change range of the wavelength may be a wavelength range of visible light. That is, the change range of the wavelength may be 400 to 700 nm.

As illustrated in FIG. 8, a measurement sensor 138 measuring the temperature and/or the humidity may be installed at one side of the accommodation space 10. The measurement sensor 138 may be installed in the upper body 130, the middle body 120, or the base 220. As an example, the measurement sensor 138 may be installed on the upper bottom plate 135a. The controller 600 may receive a measurement value of the measurement sensor 138.

The controller 600 may control the current applied to the RGBW LED 423 according to the measurement value of the measurement sensor 138. The wavelength of the light emitted by the second light 420 may vary depending on the measurement value of the measurement sensor 138. Therefore, a color stimulus of the light reflected on the rear surface of the accommodation space 10 may vary depending on the measurement value of the measurement sensor 138.

The color stimulus is a term that means a stimulus which reflected light of a colored object gives to the color sense of the eye. When the eye of the person is stimulated by the light, there are three color senses of sensing red, green, and blue, and the color may be displayed by a stimulus amount (triple stimulus value) for three color senses.

A current amount applied to the RGBW LED 423 may be set in the controller 600 according to the measurement value of the measurement sensor 138. Alternatively, the user may input the current amount applied to the RGBW LED 423 according to the measurement value of the measurement sensor 138 into the controller 600 through the operating button 610.

An appropriate temperature range may be input into the controller 600. The appropriate temperature range may mean a temperature range suitable for keeping the shoe S. The controller 600 may change the current amount applied to the RGBW LED 423 according to the measurement value of the measurement sensor 138 being within the appropriate temperature range.

As an example, when the measurement value of the measurement sensor 138 is within the appropriate temperature range, the controller 600 may apply the current to the RGBW LED 423 so that the second light 420 emits green or blue light.

As an example, when the measurement value of the measurement sensor 138 is out of the appropriate temperature range, the controller 600 may apply the current to the RGBW LED 423 so that the second light 420 emits red light.

Alternatively, when the measurement value of the measurement sensor 138 is out of the appropriate temperature range, the controller 600 may apply the current to the RGBW LED 423 so that the second light 420 continuously flashes light of a specific color.

An appropriate humidity range may be input into the controller 600. The appropriate humidity range may mean a humidity range suitable for keeping the shoe S. The controller 600 may change the current amount applied to the RGBW LED 423 according to the measurement value of the measurement sensor 138 being within the appropriate humidity range.

As an example, when the measurement value of the measurement sensor 138 is within the appropriate humidity range, the controller 600 may apply the current to the RGBW LED 423 so that the second light 420 emits the green or blue light.

As an example, when the measurement value of the measurement sensor 138 is out of the appropriate humidity range, the controller 600 may apply the current to the RGBW LED 423 so that the second light 420 emits the red light.

Alternatively, when the measurement value of the measurement sensor 138 is out of the appropriate humidity range, the controller 600 may apply the current to the RGBW LED 423 so that the second light 420 continuously flashes light of a specific color.

As illustrated in FIGS. 21 and 23, the heat dissipation cover 424 and the transmission cover 425 may be formed to be long in the second direction Y.

The light source module 421 may be connected to the heat dissipation cover 424. The heat dissipation cover 424 may form the opening at the lower side thereof. The transmission cover 425 may be coupled to at the heat dissipation cover 424 so as to seal the opening of the heat dissipation cover 424.

A hook 424a may be formed in any one of the heat dissipation cover 424 and the transmission cover 425. A holing hole 425b to which the hook 424a is hooked may be formed in any one of the heat dissipation cover 424 and the transmission cover 425. As the transmission cover 425 seals the opening of the heat dissipation cover 424, the hook 424a may be hooked to the hooking hole 425b. Therefore, the coupling force may be formed between the heat dissipation cover 424 and the transmission cover 425.

Therefore, the heat dissipation cover 424 and the transmission cover 425 may form a space (hereinafter, referred to as ‘light source space’) accommodating the light source module 421 jointly. The light source space may be formed to be long in the second direction Y.

The top of the module substrate 422 may be coupled to the heat dissipation cover 424 above the light source space. Thermal energy of the light source module 421 may be delivered to the heat dissipation cover 424. The heat dissipation cover 424 may discharge heat of the light source module 421 to the upper space 130a. The heat dissipation cover 424 may be made of a metallic material having high thermal conductance.

The LED 423 may be provided on the bottom of the module substrate 422. The transmission cover 425 may include a transmission portion 425a that penetrates light of the light source module 421. The transmission portion 425a may be formed to be long in the second direction Y.

Therefore, the light of the light source module 421 which penetrates the transmission portion 425a may form a substantially constant illuminance in the second direction Y. The transmission cover 425 may be made of a transparent glass or resin material. The front surface of the transmission cover 425 except for the transmission portion 425a may be coated with an opaque material.

A hole (hereinafter, referred to as ‘rear surface hole’) into which the transmission portion 425a is inserted may be formed on the upper bottom plate 135a. The rear surface hole may be formed to be long in the second direction Y. The transmission portion 425a may be inserted into the rear surface hole. The outer surface of the transmission portion 425a may be in close contact with the inner surface of the rear surface hole. Therefore, the gas flow of the upper space 130a and the accommodation space 10 through the transmission cover 425 and the inner surface of the rear surface hole may be stopped.

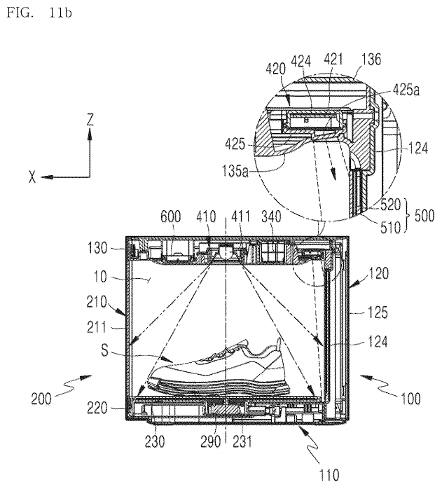

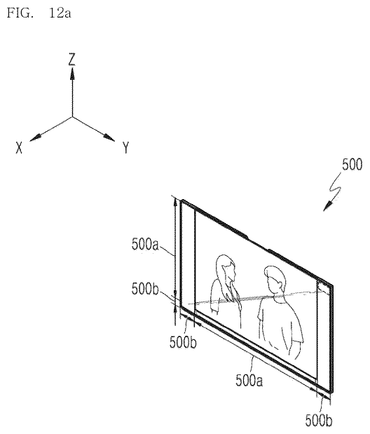

FIG. 11a is a cross-sectional view of the shoe care apparatus 1 of FIG. 3b taken along line C-C. FIG. 11b is a cross-sectional view of the shoe care apparatus 1 of FIG. 3a taken along line A-A. The alternate long and short dash line illustrated in FIG. 11b may mean the extension line of the vertical axis 231.

The accommodation space 10 may be parallel to the first direction X which is the horizontal direction and form the symmetry based on the reference surface RP which is the vertical surface. The extension line of the vertical axis 231 may be positioned within the reference plane RP.

As illustrated in FIGS. 24a and 24b, the light source 411 may be provided on the extension line of the vertical axis 231. The first light 410 may irradiate light to the top of the turntable 230 on which the shoe S is placed on the extension line of the vertical axis 231.

An alternate long and short dash line arrow illustrated in FIGS. 24a and 24b may mean the extension line of the first reflection surface 413d. An alternate long and two short dashes line arrow illustrated in FIGS. 24a and 24b may mean the extension line of the second reflection surface 412f.

As described above, in the state in which the accommodation space 10 is opened, the user may place the shoe S on the top of the turntable 230 by holding any one part (heel top, lining, tong, etc.) of the shoe S.

Thereafter, the user manipulates the operating button 610 to rotate the turntable 230 at a predetermined angle so that the front and rear direction of the shoe S coincides with the first direction X.

Alternatively, the user manipulates the operating button 610 to rotate the turntable 230 at a predetermined angle so that the front and rear direction of the shoe S form a predetermined angle with the first direction X. Alternatively, the user manipulates the operating button 610 to continuously rotate the turntable 230.

A beam angle of the first light 410 may form the axial symmetry around the vertical axis 231. Therefore, the light emitted by the first light 410 may form the same illuminance around the vertical axis 231 in the circumferential direction.

Therefore, light reflected on the surface of the shoe S may maintain the same color stimulus regardless of a direction which the front and rear direction of the shoe S faces. Therefore, the aesthetics and the color sense of the shoe S stored in the accommodation space 10 may be maintained to be the same regardless of the direction which the front and rear direction of the shoe S faces.

As described above, the transparent window 210 may form the front surface, and both side surfaces (the left surface and the right surface) of the accommodation space 10. The transparent window 210 may include the first window 211, the second window 212, and the third window 213.

The first window 211 may form the front surface of the accommodation space 10. The second window 212 may form the left surface of the accommodation space 10. The third window 213 may form the right surface of the accommodation space 10.

Therefore, the user may observe the shoe S accommodated in the accommodation space 10 at the front side, the left side, and the right side. Further, the user may observe the shoe S accommodated in the accommodation space 10 between front side and the left side and between the front side and the right side of the accommodation space 10.

The beam angle of the first light 410 forms the axial symmetry around the vertical axis 231, and as a result, the light reflected on the surface of the shoe S may maintain the same color stimulus regardless of the location of the user based on the accommodation space 10. Therefore, the aesthetics and the color sense of the shoe S stored in the accommodation space 10 may be maintained to be the same.

Hereinafter, for easy understanding of the present invention, a space between the extension line of the vertical axis 231 and the extension line of the first reflection surface 413d will be referred to as ‘first space’. In addition, a space between the extension line of the first reflection surface 413d and the extension line of the second reflection surface 412f will be referred to as ‘second space’.

As illustrated in FIG. 8, the first reflection surface 413d may be provided next to the light source 411 around the extension line of the vertical axis 231. The second reflection surface 412f may be provided below the first reflection surface 413d. The first reflection surface 413d and the second reflection surface 412f may form a surface reflecting the light of the light source 411 toward the accommodation space 10.

The second reflection surface 412f may be spaced apart from the extension line of the vertical axis 231 further than the first reflection surface 413d. In addition, the extension line of the second reflection surface 412f may be spaced apart from the vertical axis 231 further than the extension line of the first reflection surface 413d. Therefore, the light reflected by the second reflection surface 412f may form a lower illuminance than the light reflected by the first reflection surface 413d.

As illustrated in FIGS. 24a and 24b, the light of the first light 410 may form a higher illuminance in the first space than the second space. The extension line of the first reflection surface 413d may face the edge of the turntable 230. Therefore, the first light 410 may intensively illuminate the shoe S placed on the top of the turntable 230. Therefore, the display effect of the shoe S placed on the top of the turntable 230 may be enhanced.

When the shoe S is placed close to the edge of the turntable 230 based on the vertical axis 231, a part of the shoe S may be positioned in the second space. Further, when the shoe S is formed to be long in the vertical direction like boots, a part of the shoe S may be positioned in the second space.

The light of the first light 410 forms a lower illuminance in the second space than the first space, a part of the shoe S positioned in the second space may be illuminated. Therefore, even though a part of the shoe S is positioned outside the first space, the first light 410 may wholly illuminate the shoe S placed on the top of the turntable 230.

Therefore, even though a part of the shoe S is positioned in the second space, the light reflected on the surface of the shoe S may generally maintain the same color stimulus. Therefore, the aesthetics and the color sense of the shoe S stored in the accommodation space 10 may be generally maintained to be the same.

The dotted line illustrated in FIG. 11b may mean the progress of the light of the second light 420 penetrating a transmission surface. A dotted-line arrow illustrated in the enlarged diagram of FIG. 11b may mean a normal direction of the transmission surface.

According to the Snell's law, when light is incident on a boundary surface of two media having different densities, the reflectance of the light increases as an incident angle increases. Therefore, the transmission portion 425a may penetrate the light of the light source module 421 having a smaller incident angle toward the accommodation space 10.

In addition, the transmission portion 425a may reflect the light of the light source module 421 having a larger incident angle. Therefore, the light of the light source module 421 which penetrates the transmission portion 425a may form a high illuminance around the normal direction of the bottom of the transmission portion 425a.

As illustrated in FIG. 11b, the normal direction of the bottom of the transmission portion 425a, which contacts the accommodation space 10 may face the front surface of the internal panel 500. The top of the transmission portion 425a may form a surface parallel to the bottom. Therefore, the second light 420 may intensively illuminate the rear surface of the accommodation space 10.

Therefore, the visibility of the rear surface of the accommodation space 10 is enhanced, and as a result, the display effect of the image sheet 550 accommodated in the internal panel 500 may be enhanced. In particular, in the state in which the light around the shoe care apparatus 1 is turned off or weak, the display effect of the image sheet 550 accommodated in the internal panel 500 may be enhanced.

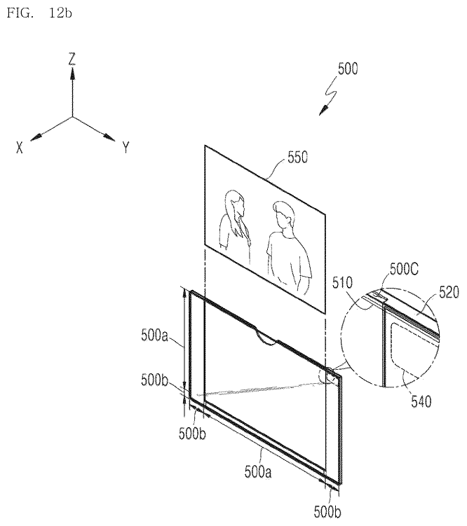

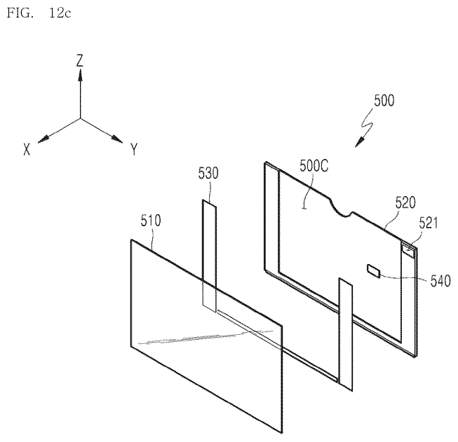

FIG. 12a is a perspective view illustrating a state in which the image sheet 550 is inserted into the insertion space 500c of the internal panel 500.

FIG. 12b is a perspective view illustrating a state in which the image sheet 550 is withdrawn from the insertion space 500c of the internal panel 500. FIG. 12c is an exploded perspective view of the internal panel 500 of FIG. 12b.

As illustrated in FIGS. 25a and 25b, the internal panel 500 may include a placement area 500a and a border area 500b.

The replacement area 500a may mean an area forming the insertion space 500c. The insertion space 500c may mean a space into which the image sheet 550 is insertable. The insertion space 500c may be opened to the upper side of the replacement area 500a. Therefore, the image sheet 550 may be inserted into the insertion space 500c above the replacement area 500a.

The image sheet 550 may be formed by a rectangular sheet. The insertion space 500c may mean a space corresponding to the shape of the image sheet 550. The insertion space 500c may be a space having a hexahedral shape which is narrow in a thickness direction. While the image sheet 550 is coupled to the body 100, the thickness direction of the insertion space 500c may be parallel to the first direction X.

The border area 500b may mean an area forming a boundary of the insertion space 500c on the bottom and both side surface of the replacement area 500a. The border area 500b may not be provided on the top of the replacement area 500a.

That is, the border area 500b may not form the boundary of the insertion space 500c on the top of the replacement area 500a. Therefore, the insertion space 500c may be opened to the upper side of the replacement area 500a.

As illustrated in FIGS. 25a to 25c, the replacement area 500a may include a front panel 510 and a rear panel 520.

The front panel 510 may penetrate light. The front panel 510 may be made of the transparent or translucent material. The front panel 510 may be manufactured by a glass or resin material.

The front panel 510 may have the rectangular plate shape. As illustrated in FIG. 11b, while the internal panel 500 is coupled to the middle body 120, the front panel 510 may form the rear surface of the accommodation space 10.

The second light 420 may illuminate the rear surface of the accommodation space 10. When the internal panel 500 is coupled to the front surface of the middle body 120, the second light 420 may illuminate the front surface of the internal panel 500. The light penetrating the front panel 510 may be reflected on the front surface of the image sheet 550 and exposed to the vision of the user.

The front panel 510 may be manufactured by a material having a large critical angle. The critical angle is an incident angle at which total reflection starts to occur when light is incident on a material having a small refractive index from a material having a large refractive index. When the critical angle is small, transmissivity of the front surface of the front panel 510 is reduced based on the light of the second light to reduce the visibility of the image sheet 550.

As an example, the critical angle of polymethyl methacrylate (PMMA) is 42.0°. The critical angle of polycarbonate (PC) is 40.2°. The critical angle of general purpose polystyrene (GPPS) is 39.3°. Therefore, based on the critical angle, the front panel 510 may be manufactured by PMMA having a largest critical angle among PMMA, PC, and GPPS.

Based on the replacement area 500a, the rear panel 520 may be spaced apart from the front panel 510 in the front and rear direction by the insertion space 500c. The front panel 510 may have the rectangular plate shape.

As illustrated in FIG. 11b, while the internal panel 500 is coupled to the middle body 120, the rear panel 520 may be in close contact with the front surface of the middle body 120.

The internal panel 500 may be selectively coupled to the front surface of the middle body 120. The internal panel 500 may also form the rear surface of the accommodation space 10 while not accommodating the image sheet 550.

While the image sheet 550 is not accommodated in the insertion space 500c, the light transmitting the front panel 510 may be reflected on the front surface of the rear panel 520 and exposed to the vision of the user. The rear panel 520 may have the same color as the front surface of the middle body 120. Therefore, even though the internal panel 500 is coupled or not coupled to the middle body 120, the accommodation space 10 may show predetermined aesthetics based on the color.

A part of the upper portion of the rear panel 520 may have a lower height than the front panel 510 at a portion where the insertion space 500c is opened.

The front panel 510 and the rear panel 520 may extend to the border area 500b. The front panel 510 and the rear panel 520 may be coupled to each other by the adhesive 530.

The adhesive 530 may be provided as an adhesive tape. The thickness of the rear panel 520 may increase in the first direction X in the border area 500b further than in the replacement area 500a. The insertion space 500c may be a space formed by a thickness difference of the rear panel 520 between the replacement area 500a and the border area 500b.

The internal panel 500 may include one or more first fastening portions 540. A concave portion (hereinafter, referred to as ‘concave portion 521’) may be formed at the upper portion of the border area 500b. The concave portion 521 may be provided in the same number as the first fastening portion 540. The first fastening portion 540 may be inserted into the concave portion 521.

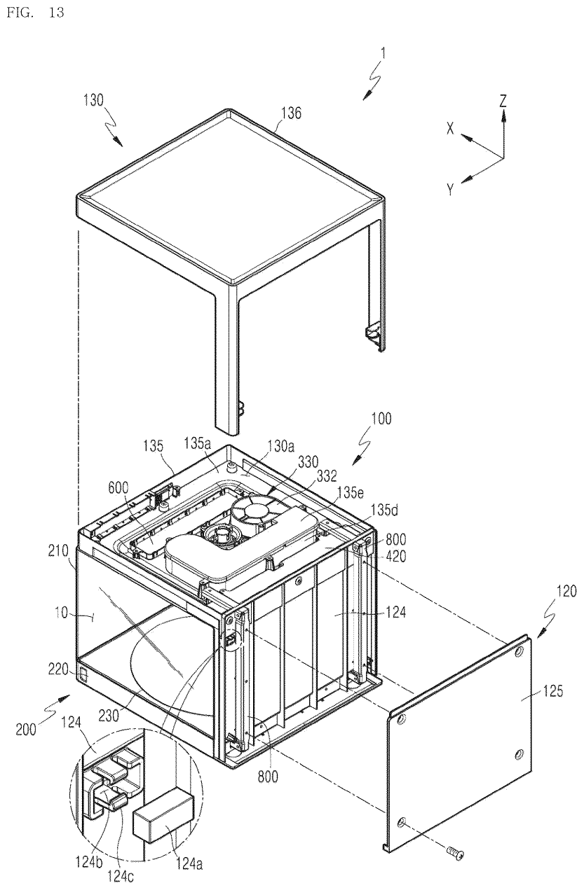

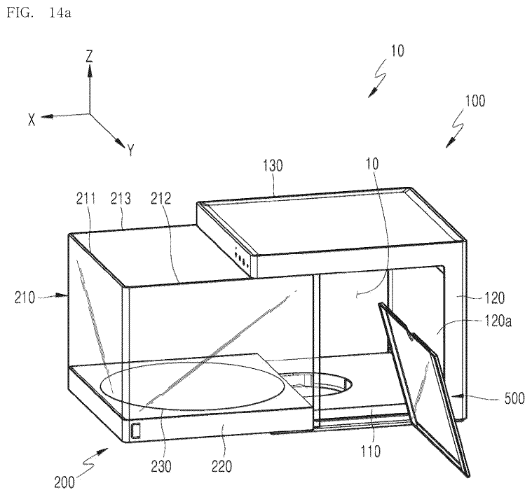

FIG. 13 is a perspective view illustrating a state in which the first external cabinet 136 and the second external cabinet 125 are separated from the body 100 of the shoe care apparatus 1 of FIG. 1a.

As illustrated in FIG. 13, the middle body 120 may include one or more second fastening portions 124a. The second fastening portion 124a may be provided in the same number as the first fastening portion 540.

The middle body 120 may include a second internal cabinet 124 and a second external cabinet 125. The first external cabinet 136 and the second external cabinet 125 may be coupled to the second internal cabinet 124 by a plurality of bolts.

The first internal cabinet 135 and the second internal cabinet 124 may be coupled to a frame body 800. The frame body 800 may be a component that forms a frame of the body 100. The strength of the body 100 may be reinforced by the frame body 800.

A fastening groove 124b may be formed on the rear surface of the second internal cabinet 124. The second fastening portion 124a may be inserted into the fastening groove 124b. A fastening protrusion 124c may be formed on the inner surface of the fastening groove 124b. The fastening protrusion 124c may prevent detachment of the second fastening portion 124a inserted into the fastening groove 124b.

At least any one of the first fastening portion 540 and the second fastening portion 124a may include a magnet. The magnet may be a permanent magnet. The first fastening portion 540 and the second fastening portion 124a may form an attraction by the magnetic force.

As an example, the first fastening portion 540 and the second fastening portion 124a may be the permanent magnets. Alternatively, any one of the first fastening portion 540 and the second fastening portion 124a may be the permanent magnet, and the other one of the first fastening portion 540 and the second fastening portion 124a may be a ferromagnetic substance such as iron, cobalt, nickel, and an alloy.

Hereinafter, for easy understanding of the present invention, a case where the moving body 200 is at a ‘first location’ (see FIGS. 1a and 1b) is intended to be defined as a ‘closed state’. When the moving body 200 is at the first location, the accommodation space 10 may be closed.

In addition, a case where the moving body 200 is at a ‘second location’ (see FIGS. 2a and 2b) is intended to be defined as an ‘opened state’. That is, when the moving body 200 is at the second location, the accommodation space 10 may be opened.

The body 100 may include the lower body 110. The lower body 110 may be positioned below the accommodation space 10. The base 220 may be movably coupled to the lower body 110 between the first location and the second location.

The first window 211, the second window 212, and the third window 213 may be coupled to the base 220. The second window 212 may form a second gap from the middle body 120 at the second location. The third window 213 may form a third gap from the middle body 120 at the second location.

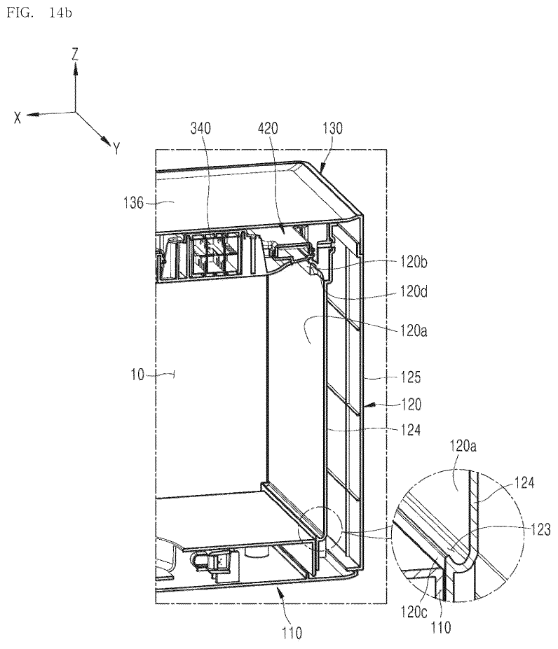

FIG. 14a as a perspective view illustrating the opened state of the accommodation space 10 of the shoe care apparatus 1 of FIG. 1a is a diagram illustrating a state in which the internal panel 500 moves through the second gap.

FIG. 14b is a cross-sectional view illustrating the opened state of the accommodation space 10 of the shoe care apparatus 1 of FIG. 14a.

As illustrated in FIG. 14a, while the accommodation space 10 is opened, the user may put the internal panel 500 into the accommodation space 10 or withdraw the internal panel 500 from the accommodation space 10 through the second gap. Alternatively, the user may put the internal panel 500 into the accommodation space 10 or withdraw the internal panel 500 from the accommodation space 10 through the third gap while slightly tilting the internal panel 500.

Therefore, the body 100 may include the middle body 120 that forms the rear surface of the accommodation space 10 jointly with the internal panel 500. While the internal panel 500 is separated from the middle body 120, the front surface of the middle body 120 may form the rear surface of the accommodation space 10.

As illustrated in FIG. 14b, a fixation groove 123 may be formed at the lower portion of the front surface of the middle body 120. The fixation groove 123 may elongate in the second longitudinal direction Y. The fixation groove 123 may be formed to be concave downward. The inner surface of the fixation groove 123 may have a predetermined curvature.

The normal line of a front surface in the first direction X of the inner surface of the fixation groove 123 may be tilted in the first direction X based on the third direction Z. Therefore, the lower portion of the internal panel 500 may be rotatable at a predetermined angle while being inserted into the fixation groove 123.

The front surface of the middle body 120 may include a first middle front surface 120a, a second middle front surface 120b, a third middle front surface 120c, and a guide surface 120d.

The first middle front surface 120a may mean a surface closely contacting the internal panel 500. The first middle front surface 120a may be provided below the fixation groove 123. The first middle front surface 120a may be connected to the inner surface of the fixation groove 123. A rear surface in the first direction X of the inner surface of the fixation groove 123 may be connected to the first middle front surface 120a.

The second middle front surface 120b may be positioned above the first middle front surface 120a. The second middle front surface 120b may be provided before the first middle front surface 120a in the first direction X.

The third middle front surface 120c may be positioned below the first middle front surface 120a. The third middle front surface 120c may be provided below the fixation groove 123. The third middle front surface 120c may be provided before the first middle front surface 120a in the first direction X. The base 220 may cover the third middle front surface 120c in the closed state.

The guide surface 120d may be positioned above the first middle front surface 120a jointly with the second middle front surface 120b. The guide surface 120d may be positioned at the center of the second middle front surface 120b based on the second direction Y. The guide surface 120d may be positioned behind the second middle front surface 120b. The guide surface 120d may form a curved surface provided behind the second middle front surface 120b downward.

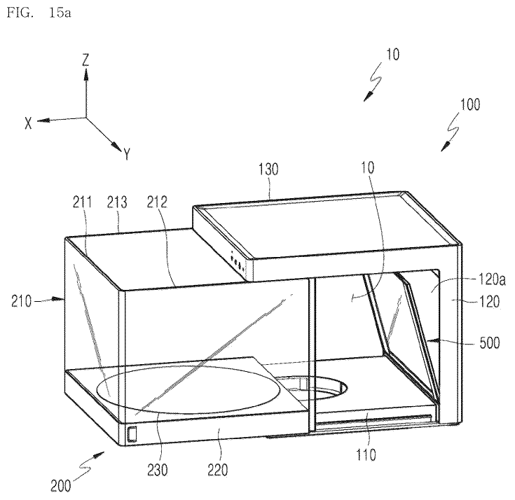

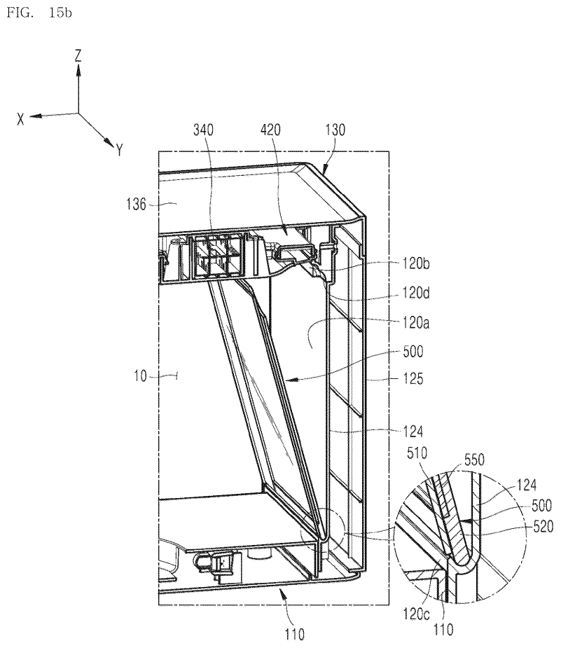

FIG. 15a as a perspective view illustrating the opened state of the accommodation space 10 of the shoe care apparatus 1 of FIG. 1a is a diagram illustrating a state in which the lower portion of the internal panel 500 is inserted into the fixation groove 123.

FIG. 15b is a cross-sectional view illustrating the opened state of the accommodation space 10 of the shoe care apparatus 1 of FIG. 15a.

As illustrated in FIGS. 28a and 28b, while the accommodation space 10 is opened, the user may insert the lower portion of the internal panel 500 into the fixation groove 123. The user may insert the lower portion of the internal panel 500 into the fixation groove 123 while being tilted slightly forward.

The bottom of the internal panel 500 may form the curved surface. The bottom of the internal panel 500 may have a curvature corresponding to the inner surface of the fixation groove 123. Therefore, the lower portion of the internal panel 500 may rotate while smoothly sliding on the inner surface of the fixation groove 123 while being inserted into the fixation groove 123.

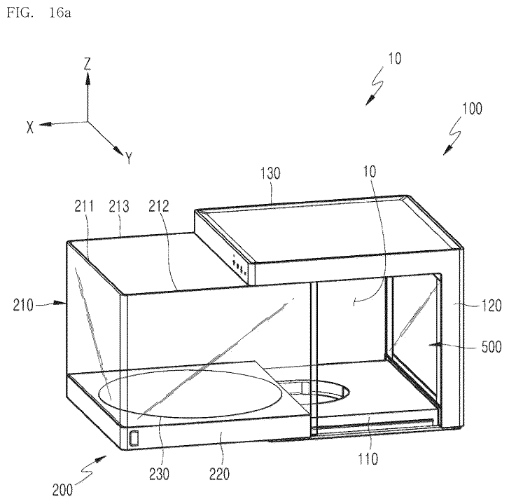

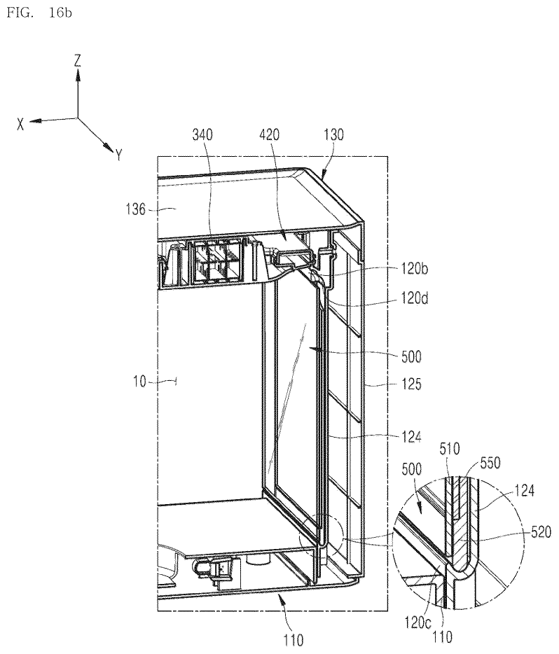

FIG. 16a as a perspective view illustrating the opened state of the accommodation space 10 of the shoe care apparatus 1 of FIG. 1a is a diagram illustrating a state in which the internal panel 500 is coupled to the middle body 120.

FIG. 16b is a cross-sectional view illustrating the opened state of the accommodation space 10 of the shoe care apparatus 1 of FIG. 16a.

As illustrated in FIGS. 29 and 29b, the internal panel 500 rotates around the fixation groove 123 to form the rear surface of the accommodation space 10 to be in close contact with the first middle front surface 120a.

The front surface of the internal panel 500 may be positioned below the second middle front surface 120b. As the internal panel 500 is in close contact with the first middle front surface 120a, the front surface of the internal panel 500 may form the rear surface of the accommodation space 10 jointly with the second middle front surface 120b.

In this state, the front surface of the internal panel 500 may form the same location as the second middle front surface 120b in the first direction X. Therefore, the front surface of the internal panel 500 and the second middle front surface 120b may be observed as an integrated surface. Therefore, the view viewing the shoe S is not distributed to the rear surface of the accommodation space 10 to enhance the display effect of the shoe S.

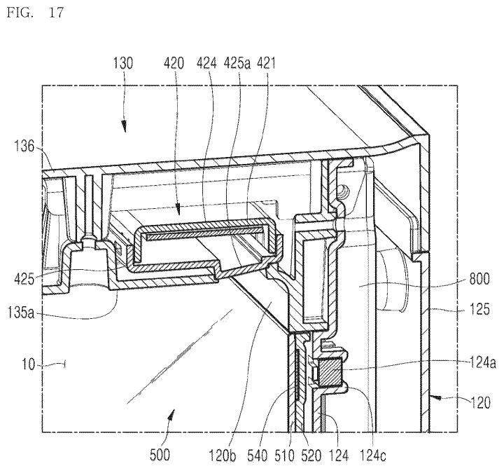

FIG. 17 as a partial cross-sectional view of the shoe care apparatus 1 of FIG. 1a is a diagram illustrating a state in which the first fastening portion 540 and the second fastening portion 124a form a coupling force to each other.

As illustrated in FIG. 17, as the internal panel 500 rotates around the fixation groove 123, the first fastening portion 540 may be positioned before the second fastening portion 124a in the first direction X. While the internal panel 500 is in close contact with the first middle front surface 120a, the first fastening portion 540 and the second fastening portion 124a may form the coupling force to each other.

Therefore, as the internal panel 500 rotates around the fixation groove 123, the first fastening portion 540 and the second fastening portion 124a form the coupling force to each other, and as a result, the internal panel 500 may be in close contact with the front surface of the middle body 120. Therefore, even though an unintended impact is not delivered to the shoe care apparatus 1, the internal panel 500 may solidly maintain the state of being in close contact with the front surface of the middle body 120.

The first fastening portion 540 may be a ferromagnetic substance such as iron, cobalt nickel, and an alloy thereof. In addition, the second fastening portion 124a may be the permanent magnet. Therefore, as the internal panel 500 rotates around the fixation groove 123, the first fastening portion 540 and the second fastening portion 124a may form the attraction by the magnetic force.

In the process in which the user rotates the internal panel 500 around the fixation groove 123, when the attraction by the magnetic force between the first fastening portion 540 and the second fastening portion 124a exceeds the rotational force of the internal panel 500 by the gravity, the internal panel 500 rotates by the attraction by the magnetic force between the first fastening portion 540 and the second fastening portion 124a to be in close contact with the front surface of the middle body 120.

In this process, the internal panel 500 may move in the second direction Y so that the first fastening portion 540 is positioned just before the second fastening portion 124a in the first direction X by the attraction by the magnetic force between the first fastening portion 540 and the second fastening portion 124a.

Therefore, the internal panel 500 may be in close contact with the front surface of the middle body 120 at a predetermined location at all times based on the second direction Y by the attraction by the magnetic force between the first fastening portion 540 and the second fastening portion 124a.

As illustrated in FIG. 16b, while the internal panel 500 is in close contact with the first middle front surface 120a, the lower portion of the guide surface 120d may be provided behind the front panel 510. In addition, the top of the rear panel 520 may have a lower height than the front panel 510 below the guide surface 120d. Therefore, while the internal panel 500 is in close contact with the first middle front surface 120a, the lower portion of the guide surface 120d may be positioned behind the upper portion of the front panel 510 in the first direction X.

Therefore, while the internal panel 500 is in close contact with the first middle front surface 120a, the lower portion of the guide surface 120d and the upper portion of the front panel 510 may form a gap in the first direction X.

While the accommodation space 10 is opened, the user may put a finger between the lower portion of the guide surface 120d and the upper portion of the front panel 510. In this case, when the front panel 510 is pulled forward in the first direction X with the finger, the internal panel 500 rotates around the fixation groove 123, and as a result, a close contact state of the first middle front surface 120a may be released.

As illustrated in FIG. 15a, as the state in which the internal panel 500 is in close contact with the first middle front surface 120a, the user may withdraw the internal panel 500 from the accommodation space 10 through the second gap and the third gap.

The user may withdraw the internal panel 500 from the accommodation space 10 through the second gap and the third gap while slightly tilting the internal panel 500. The user may replace the image sheet 550 accommodated in the internal panel 500.

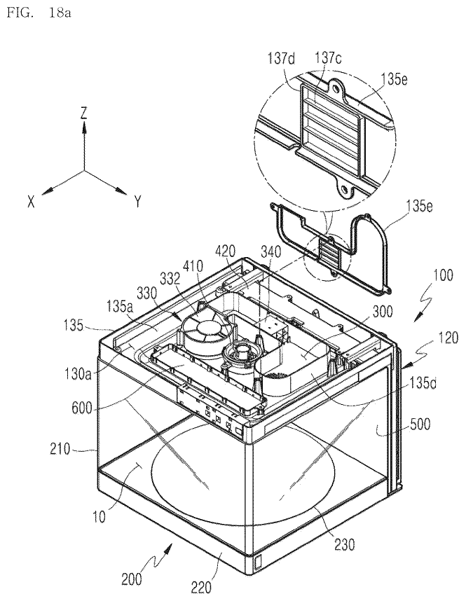

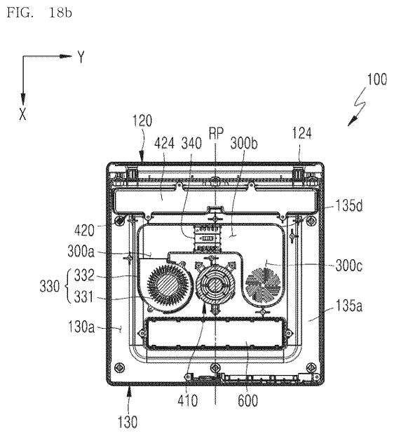

FIG. 18a is a perspective view illustrating a state in which the first external cabinet 36 is removed from the body 100 of the shoe care apparatus 1 of FIG. 1a. FIG. 18a illustrates a state in which a path cover 135e of the air path 300 is separated.

FIG. 18b is a cross-sectional view of the shoe care apparatus 1 of FIG. 3a taken along line B-B.

As illustrated in FIGS. 31a and 31b, the shoe care apparatus 1 according to the embodiment of the present invention may include the body 100, the moving body 200, the blowing part 330, the first light 410, and the air path 300.

The body 100 and the moving body 200 may form the accommodation space 10 accommodating the shoe S jointly. The body 100 and the moving body 200 may be coupled to move with respect to each other. The moving body 200 may be coupled to the body 100 to reciprocally move in the front and rear direction.

The body 100 may include the upper body 130. The upper body 130 may be positioned above the accommodation space 10. The upper body 130 may have an upper space 130a of which gas flow is disconnected from the accommodation space therein. The upper space 130a may have a hexahedral shape in which lengths in the first direction X and the second direction Y are larger than a length in the third direction Z.

The upper body 130 may include a first internal cabinet 135 and a first external cabinet 136. The first internal cabinet 135 and the first external cabinet 136 may form the accommodation space 10 jointly.

As illustrated in FIG. 18a, the first internal cabinet 135 may have a rectangular box shape opened upward. The first internal cabinet 135 may have an air path 300 connected to the accommodation space 10. The first internal cabinet 135 may include the upper bottom plate 135a, a path barrier 135d, and the path cover 135e.

The upper bottom plate 135a may partition the accommodation space 10 and the upper space 130a. The upper bottom plate 135a may have a plate shape which is wide in the horizontal direction. The lower surface of the upper bottom plate 135a may form the upper surface of the accommodation space 10.

The upper surface of the top bottom plate 135a may form the bottom of the upper space 130a. The suction port 310 and the discharge port 420 may be formed on the upper bottom plate 135a. The air in the accommodation space 10 may be suctioned into the air path 300 through the suction port 310. The air in the air flow path 300 may be discharged to the accommodation space 10 through the discharge port 320.

The accommodation space 10 may exchange thermal energy with outside air through the first external cabinet 136. Therefore, the temperature of the accommodation space 10 may vary depending on the temperature of the outside air. The air path 300 is provided above the accommodation space 10, and the air flow the air path 300 to/from the upper space 130a may be stopped.

Therefore, the shoe care apparatus 1 according to the embodiment of the present invention may control the temperature of air circulated in the accommodation space 10 and the air path 300 regardless of the temperature variation of the outside air. Therefore, the accommodation space 10 may maintain an optimal temperature at which the shoe S may be appropriately kept.

The blowing part 330 is a component that circulates the air in the accommodation space 10 and the air path 300. The blowing part 330 and the air path 300 may be provided above the upper bottom plate 135a.

The blowing part 330 may include the fan 331 and the fan housing 332. The fan 331 may pressure-feed the air by the rotary movement of the impeller. The fan 331 may be provided inside the air path 300.

A power supply (not illustrated) may be provided in the base 220. The power supply may supply power to the fan 331. The controller 600 may control the power supplied to the fan 331 from the power supply.

The fan housing may be coupled to the top of the upper bottom plate 135a above the suction port 310. The fan housing 332 may be provided inside the air path 300 above the suction port 310. Alternatively, the fan housing 332 may constitute a part of the air path 300 above the suction port 310.

The path barrier 135d may protrude upward on the top of the upper bottom plate 135a. The path barrier 135d may form a side all of the air path 300 jointly with the fan housing 332.

The path cover 135e may close an upper opening of the path barrier 135d. The path cover 1353 may form a ceiling portion of the air path 300 jointly with the fan housing 332. The path cover 135e may be detachably coupled to the upper bottom plate 135e by the bolt.

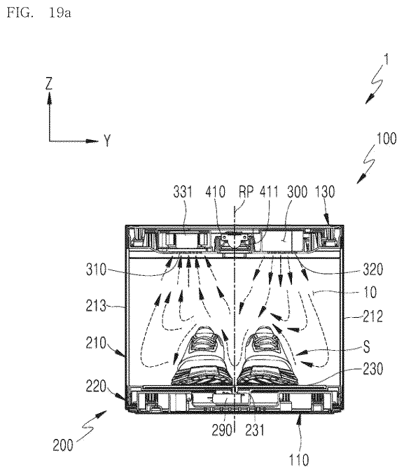

FIG. 19a is a cross-sectional view of the shoe care apparatus 1 of FIG. 3b taken along line C-C. FIG. 19a illustrates an air flow in the accommodation space while the front side of the shoe S faces the front side in the first direction X.

FIG. 19b is a cross-sectional view of the shoe care apparatus 1 of FIG. 3b taken along line C-C. FIG. 19b illustrates the air flow in the accommodation space while the front side of the shoe S faces the rear side in the second direction Y.

As illustrated in FIGS. 32a and 32b, the moving body 200 may include the base 220, the turntable 230, and the transparent window 210.

The body 100 may include the lower body 110. The lower body 110 may be positioned below the accommodation space 10. The base 220 may be coupled to the lower body 110 to be relatively movable in the front and rear direction so as to open/close the accommodation space 10. The transparent window 210 may be coupled to the base 220. The transparent window 210 may form the front surface, and both side surfaces (the left surface and the right surface) of the accommodation space 10.

The turntable 230 may be rotatably coupled to the base 220 around a vertical axis 231. The base 220 and the turntable 230 may form the lower surface of the accommodation space 10 jointly. The upper surface of the turntable 230 may have the circular shape around the vertical axis 231.

The motor 290 may be provided in the base 220. The motor 290 may deliver the rotary movement to the turntable 230. The rotational axis 231 of the turntable 230 may be in line with the vertical direction. The axis of the motor 290 may be directly coupled to the rotational axis 231 of the turntable 230.

The first light 410 may irradiate light to the top of the turntable 230 on which the shoe S is placed on the extension line of the vertical axis 231. The first light 410 may be coupled to the upper bottom plate 135a.

As illustrated in FIG. 18b, the suction port 310 and the discharge port 320 of the air path 300 may be formed at opposite sides to each other in the horizontal direction based on the first light 410. A path of the air path 300 may be formed along a horizontal circumference of the first light 410.

The first light 410 may be provided on the extension line of the vertical axis 231. Therefore, the suction port 310 and the discharge port 320 of the air path 300 may be formed at opposite sides to each other in the horizontal direction based on the extension line of the vertical axis 231. The accommodation space 10 may be parallel to the first direction X which is the horizontal direction and form the symmetry based on the reference surface RP which is the vertical surface. The extension line of the vertical axis 231 may be positioned within the reference plane RP.

As the first light 410 and the air path 300 are placed in the upper space 130a in the horizontal direction, the upper space 130a may be formed to have a low height. An increase in height of the upper space 130a may be in proportion to an increase in volume of the shoe care apparatus 1. A volume increase of home appliances may be a major factor which reduces installability and usability, and raises product prices.

The first light 410 and the air path 300 are placed in the upper space 130a in the horizontal direction, and as a result, the upper space 130a may be efficiently utilized, and the installability and usability of the shoe care apparatus 1 may be increased.

As an example, the suction port 310 and the discharge port 320 of the air path 300 may be formed at opposite sides to each other based on the first light 410. In this case, the path of the air path 300 may be formed along the horizontal circumference of the first light before or behind the first light 410 in the first direction X.

Alternatively, the suction port 310 and the discharge port 320 of the air path 300 may also be formed at opposite sides to each other in the front and rear direction based on the first light 410. In this case, the path of the air path 300 may be formed along the horizontal circumference of the first light 410 before or behind the first light 410 in the second direction Y.

A placement form of the suction port 310, the discharge port 320, and the air path 300 based on the first light 410 may be decided in association with the placement of the controller 600 and the second light 420.

When the controller 600 is placed in front in the second direction Y in the upper space 130a, the suction port 310 and the discharge port 320 of the air path 300 may be formed at opposite sides to each other in the front and rear direction based on the first light 410. In this case, the path of the air path 300 may be formed along the horizontal circumference of the first light 410 behind the first light 410 in the second direction Y.

Alternatively, when the controller 600 is placed in the rear in the second direction Y in the upper space 130a, the suction port 310 and the discharge port 320 of the air path 300 may be formed at opposite sides to each other in the front and rear direction based on the first light 410. In this case, the path of the air path 300 may be formed along the horizontal circumference of the first light 410 before the first light 410 in the second direction Y.

As illustrated in FIG. 18b, when the controller 600 is placed in front in the first direction X in the upper space 130a, the suction port 310 and the discharge port 320 of the air path 300 may be formed at opposite sides to each other in the left and right direction based on the first light 410. In this case, the path of the air path 300 may be formed along the horizontal circumference of the first light 410 behind the first light 410 in the first direction X.

As illustrated in FIGS. 32a and 32b, the suction port 310 and the discharge port 320 may form the same gap from the vertical axis 231. That is, the suction port 310 and the discharge port 320 of the air path 300 may be formed at opposite sides to each other in the horizontal direction based on the vertical axis 231, and spaced apart with the same gap from the vertical axis 231.

Therefore, an area where the air drops descends at the discharge port 320 as a starting point and an area where the air rises at the suction port 310 as an ending point in the accommodation space 10 are parallel to the first direction X which is the horizontal direction, and are divided based on the reference plane RP which is the vertical plane, and as a result, the air circulation in the accommodation space 10 may be smooth. Further, even though a direction in which the shoe S is placed is changed while the turntable 230 rotates, a uniform air flow may be formed on the entire surface of the shoe S placed on the top.

As illustrated in FIGS. 31a and 31b, the air path 300 may include a first path 300a, a second path 300b, and a third 300c.

The first path 300a may be formed to extend to the rear side in the first direction X from the upper portion of the suction port 310. The first path 300a may form a path in which the air in the accommodation space 10 suctioned from the suction port 310 by the blowing part 330 flows to the rear in the first direction X.

The fan housing may form a part of the first path 300a. The path barrier 135d constituting the first path 300a may be coupled to a side portion of the fan housing 332. The path cover 1353 constituting the first path 300a may be coupled to a top portion of the fan housing 332. The upper bottom plate 135a may form the bottom of the first path 300a.

The third path 300c may be formed to extend to the rear side in the first direction X from the upper portion of the discharge port 320. The third path 300c may form a path in which the air in the second path 300b flows to the front in the first direction X. The air in the third path 300c may be discharged to the accommodation space 10 through the discharge port 320.

The second path 300b may be formed to connect the first path 300a and the third path 300c in the second direction Y. The second path 300b may form a path in which the air in the first path 300a flows to the front in the second direction Y. The heating part 340 may be provided in the second path 300b. The heating part 340 may deliver thermal energy to the air which moves in the air path 300.

The path barrier 135d may form side surfaces of the second path 300b and the third path 300c. The path cover 1353 may form tops of the second path 300b and the third path 300c. The upper bottom plate 135a may form bottoms of the second path 300b and the third path 300c.

FIG. 20 is a perspective view illustrating the heating part 340 of the shoe care apparatus 1 of FIG. 18a.

FIG. 21 is a perspective cross-sectional view of the shoe care apparatus 1 of FIG. 3a taken along line A-A. FIG. 21 does not illustrate the shoe S.

As illustrated in FIGS. 33 and 34, the heating part 340 may include the heat wire 341 and the heat dissipation member 342.

The heat wire 341 may be a hot wire for generating heat through current. The controller 600 controls the current which flows on the heat wire 341 to control the temperature of the heating part 340. The heat wire 341 may be connected to the heat dissipation member 342.

A power supply (not illustrated) may be provided in the base 220. The power supply may supply power to the heat wire 341. The controller 600 may control the power supplied to the heat wire 341 from the power supply.

The measurement sensor 138 that measures the temperature and/or the humidity of the accommodation space 10 may be installed at one side of the accommodation space 10. The measurement sensor 138 may be installed in the upper body 130, the middle body 120, or the base 220. As an example, the measurement sensor 138 may be installed on the upper bottom plate 135a. The controller 600 may receive the measurement value of the measurement sensor 138.

The operating time and the operating pattern of the blowing part 330 and the heating part 340, and the current amount applied to the heating part 340 according to the measurement value of the load sensor may be set in the controller 600.

The user may input the operating time and the operating pattern of the blowing part 330 and the heating part 340, and the current amount applied to the heating part 340 according to the temperature and/or the humidity of the accommodation space 10 into the controller through the operating button 610.

The controller 600 may control the current applied to the heat wire 341 according to the measurement value of the measurement sensor 138. The temperature of the heat wire 341 may vary depending on the measurement value of the measurement sensor 138. Therefore, the shoe care apparatus 1 according to the embodiment of the present invention controls the temperature and/or the humidity of the accommodation space 10 to completely interrupt the deformation or the contamination of the shoe S.

As illustrated in FIG. 18b, the heat dissipation member 342 may form a contact surface with the air which moves in the air path 300. Therefore, the thermal energy of the heat wire 341 may be delivered to the air which flows in the air path 300 through the heat dissipation member 342.

As illustrated in FIGS. 33 and 34, the heat dissipation member 342 may include a first heat dissipation plate 343 and a second heat dissipation plate 344. The first heat dissipation plate 343 may include a first horizontal heat dissipation plate 343a and a first vertical heat dissipation plate 343b.

The first horizontal heat dissipation plate 343a may be formed in a plate shape parallel to the upper bottom plate 135a. The top and the bottom of the first horizontal heat dissipation plate 343a may form the contact surface with the air which flows in the air path 300. One or more first horizontal heat dissipation plates 3 may be provided. A plurality of first horizontal heat dissipation plates 3 may be spaced apart in the vertical direction.

The first vertical heat dissipation plate 343b may be formed in the plate shape parallel to an adjacent path barrier 135d. Both surfaces of the first vertical heat dissipation plate 343b may form the contact surface with the air which flows in the air path 300. One or more first vertical heat dissipation plates 343b may be provided. A plurality of first vertical heat dissipation plates 343b may be spaced apart in the width direction of the air path 300.

A thermal fuse may be coupled to any one of the first horizontal heat dissipation plate 343a and the first vertical heat dissipation plate 343b. The thermal fuse is deformed or melted at a setting temperature to open an electrical circuit. Therefore, overheating and fire of the shoe care apparatus 1 may be prevented.

A plurality of winding holes 343c may be formed on the first horizontal heat dissipation plate 343a and the first vertical heat dissipation plate 343b.

FIG. 22a is a perspective cross-sectional view of the air path 300 of the shoe care apparatus 1 of FIG. 11 taken along line D-D.

As illustrated in FIG. 22a, the winding holes 343c of the first horizontal heat dissipation plate 343a may be spaced apart from each other in a movement direction of the air which flows in the air path 300. The winding holes 343c of the first vertical heat dissipation plate 343b may be spaced apart from each other in the movement direction of the air which flows in the air path 300. The heat wire 341 may be wound while passing through the winding holes 343c of the first horizontal heat dissipation plate 343a and the first vertical heat dissipation plate 343b.

The winding holes 343c may be formed in a zigzag form in a path direction of the air path 300. All of the winding holes 343c of the first horizontal heat dissipation plate 343a and the first vertical heat dissipation plate 343b may be formed in the zigzag form in the path direction of the air path 300. Alternatively, only the winding holes 343c of any one of the first horizontal heat dissipation plate 343a and the first vertical heat dissipation plate 343b may be formed in the zigzag form in the path direction of the air path 300.

As illustrated in FIG. 22a, only the winding holes 343c of the first vertical heat dissipation plate 343b may be formed in the zigzag form in the path direction of the air path 300. Therefore, the heat wire 341 wound on the winding holes 343c of the first vertical heat dissipation plate 343b may be undulated with each other in the vertical direction. Therefore, thermal energy directly delivered from the heat wire 341 to the air may increase.

Therefore, even though the controller 600 supplies relatively small current to the heat wire 341, larger thermal energy may be delivered to the air which flows in the accommodation space 10. Therefore, a current amount required for operating the shoe care apparatus 1 may be reduced.

FIG. 22b as a partial enlarged diagram of the shoe care apparatus 1 of FIG. 11 is a diagram illustrating the air path 300.

As illustrated in FIGS. 22a and 22b, a spacing projection portion 137 may be formed on the inner surface of the air path 300. The spacing projection portion 137 may be project from the inner surface of the air path 300. The heat dissipation member 342 may be separated from the inner surface of the air path 300 by the spacing projection portion 137.

The spacing projection portion 137 may include a first spacing projection portion 137a, a second spacing projection portion 137b, and a third spacing projection portion 137c.

The first spacing projection portion 137a may be projected toward the air path 300 from the top of the upper bottom plate 135a. The second spacing projection portion 137b may be projected toward the air path 300 from both inner surfaces of the path barrier 135d. The third spacing projection portion 137c may be projected toward the air path 300 from the bottom of the path cover 135e.

As illustrated in FIGS. 22a and 35b, the second heat dissipation plate 344 may be formed to be in line with the inner surface of the air path 300. The second heat dissipation plate 344 may include a second horizontal heat dissipation plate 344a and a second vertical heat dissipation plate 344b.

The second horizontal heat dissipation plate 344a may be coupled to each of the upper portion and the lower portion of the first horizontal heat dissipation plate 343a. The second horizontal heat dissipation plate 344a may form the contact surface with the air which flows in the air path 300.

The lower second horizontal heat dissipation plate 344a may be formed in the plate shape parallel to the upper bottom plate 135a. The lower second horizontal heat dissipation plate 344a may be spaced upward from the top of the upper bottom plate 135a by the first spacing projection portion 137a.

The first spacing projection portion 137a may be formed to be long in line with the path direction of the air path 300. Therefore, a path in which air flows may be formed between the lower second horizontal heat dissipation plate 344a and the upper bottom plate 135a. Therefore, the thermal energy of the air path 300 may be delivered to the accommodation space 10 in the form of heat conducting through the upper bottom plate 135a. Therefore, operation efficiency of the heating part 340 may be enhanced.

The upper second horizontal heat dissipation plate 344a may be formed in the plate shape parallel to the path cover 135e. The upper second horizontal heat dissipation plate 344a may be spaced downward from the bottom of the path cover 1353 by the third spacing projection portion 137c.

As illustrated in FIGS. 22a and 22b, the upper body 130 may include the first external cabinet 136 that partitions the outside and the upper space 130a. A wall surface of the air path 300 may be spaced apart from the first external cabinet 136 in the upper and lower direction. That is, the path cover 135e may be spaced apart from the first external cabinet 136 in the upper and lower direction.

As described above, an increase in height of the upper space 130a may be in proportion to an increase in volume of the shoe care apparatus 1. A volume increase of home appliances may be a major factor which reduces installability and usability, and raises product prices. Therefore, an up-down direction spacing distance between the path cover 135e and the first external cabinet 136 should be minimized.

However, as the up-down direction spacing distance between the path cover 135e and the first external cabinet 136 decreases, an amount of the thermal energy of the air path 300, which is dispersed to the outside air increases by the heat delivery through the path cover 135e and the first external cabinet 136, so the operating efficiency of the heating part 340 may be lowered.

As illustrated in FIG. 18a, an isolation projection portion 137d may be formed at a portion close to the first external cabinet 136 on the inner surface of the air path 300. The portion close to the first external cabinet 136 on the inner surface of the air path 300 may mean the bottom of the path cover 135e.

As illustrated in FIGS. 22a and 22b, the isolation projection portion 137d may be formed to surround the edge of the upper second horizontal heat dissipation plate 344a. Therefore, the isolation projection portion 137d may isolate space (hereinafter, referred to as ‘heat insulation space 300d’) between the bottom of the path cover 135e and the upper second horizontal heat dissipation plate 344a from the air path 300.

The heat insulation space 300d may form a space isolated from the air path 300 and the upper space 130a. Therefore, the thermal energy of the air path 300 delivered to the path cover 135e may be reduced by the heat insulation space 300d.

Therefore, even though the up-down direction spacing distance between the path cover 135e and the first external cabinet 136 decreases, the amount of the thermal energy of the air path 300, which is dispersed to the outside air is minimized by the heat delivery through the path cover 135e and the first external cabinet 136, so the operating efficiency of the heating part 340 may be enhanced.

The second horizontal heat dissipation plate 344b may be coupled to each of the left side and the right side of the first horizontal heat dissipation plate 343a. The second vertical heat dissipation plate 344b may be formed in the plate shape parallel to the adjacent path barrier 135d. The second vertical heat dissipation plate 344b may form the contact surface with the air which flows in the air path 300. The second vertical heat dissipation plate 344b may be spaced apart from the path barrier 135d by the second spacing projection portion 137d.

When the thermal energy of the air path 300 is dispersed to the upper space 130a by the heat delivery through the path barrier 135d, the operating efficiency of the heating part 340 may be lowered.

The second spacing projection portion 137b may be formed to be long in an orthogonal direction to the path direction of the air path 300. The second spacing projection portion 137b may prevent the air flow between the path barrier 135d and the second vertical heat dissipation plate 344b. Therefore, the thermal energy of the air path 300 delivered to the upper space 130a between the path barrier 135d and the second vertical heat dissipation plate 344b may be reduced.

Therefore, even though the spacing distance between the path barrier 135d and the second vertical heat dissipation plate 344b decreases, the amount of the thermal energy of the air path 300, which is dispersed to the upper space 130a is minimized by the heat delivery through the path barrier 135d, so the operating efficiency of the heating part 340 may be enhanced.

Hereinabove, a specific embodiment of the present disclosure is described and illustrated, but the present invention is not limited to the disclosed embodiment, and it may be appreciated by those skilled in the art that the embodiment can be variously modified and transformed to another specific embodiment without departing from the spirit and the scope of the present invention. Therefore, the scope of the present disclosure will not be defined by the described embodiment, but defined by the technical spirit disclosed in the claims.

### INDUSTRIAL APPLICABILITY

The shoe care apparatus according to the present invention achieves both a shoe display effect of displaying a shoe and a shoe care effect of preventing the deformation or contamination of the shoe, and is configured such that a light for illuminating the shoe and an air flow channel serving as an air circulation path form a compact arrangement structure above an accommodation space. In this respect, the present invention exceeds the limits of the existing technology, and thus may provide sufficient possibilities for the market or sale of a device to which the related technology is applied, not just the use of the related technology, and may be realistically and clearly practiced. Therefore, the present invention is industrially applicable.

1-15. (canceled)

16. A shoe care apparatus comprising:
an accommodation space for accommodating shoes therein;
a first body including an air flow channel connected to the accommodation space;
a second body including a transparent window, the first body and the second body being configured to define the accommodation space;
a blower configured to circulate air in the accommodation space and the air flow channel; and
a first light located in the first body above the accommodation space, the first light being configured to illuminate a shoe placed on a bottom surface of the accommodation space,
wherein a portion of the air flow channel extends along a portion of a perimeter of the first light.

17. The shoe care apparatus of claim 16, wherein the air flow channel includes a suction port and a discharge port on opposite sides of the first light.

18. The shoe care apparatus of claim 17, wherein the second body further includes:
a base, the transparent window being coupled to the base; and
a turntable coupled to the base, the turntable being configured to rotate about a vertical axis, the turntable and the base defining the bottom surface of the accommodation space, and
wherein the first light is positioned along the vertical axis.

19. The shoe care apparatus of claim 18, wherein the suction port and the discharge port are spaced equidistant from the vertical axis.

20. The shoe care apparatus of claim 19, wherein a top surface of the turntable is circular, and
wherein the first light is configured to emit light onto the top surface of the turntable.

21. The shoe care apparatus of claim 19, wherein the first body comprises a lower body located below the accommodation space, and wherein the base is coupled to the lower body, the base being movable relative to the lower body to open and close the accommodation space.

22. The shoe care apparatus of claim 19, wherein the transparent window includes:
a first window defining a front surface of the transparent window;
a second window defining a left surface of the transparent window; and
a third window defining a right surface of the transparent window.

23. The shoe care apparatus of claim 16, wherein the first body further includes an upper body defining a top surface of the accommodation space, the upper body having an upper space separated from the accommodation space,
wherein the air flow channel is located above the accommodation space, and
wherein the air flow channel is separated from the upper space.

24. The shoe care apparatus of claim 23, further comprising:
a heater configured to heat the air moving along the air flow channel; and
a controller configured to control a temperature of the heater.

25. The shoe care apparatus of claim 24, wherein the heater comprises:
a heating wire; and
a heat dissipation member coupled to the heating wire, the heat dissipation member being in contact with the air moving along the air flow channel.

26. The shoe care apparatus of claim 25, wherein the air flow channel includes a first spacing projection on a first inner surface of the air flow channel to space the heat dissipation member from the first inner surface of the air flow channel.

27. The shoe care apparatus of claim 26, wherein the heat dissipation member comprises a first heat dissipation plate having a plurality of winding holes through which the heating wire is wound.

28. The shoe care apparatus of claim 27, wherein the winding holes are arranged in a zigzag pattern along a portion of the air flow channel.

29. The shoe care apparatus of claim 27, wherein the upper body comprises an upper bottom plate configured to separate the upper space from the accommodation space, the upper bottom plate defining the first inner surface of the air flow channel, and
wherein the first spacing projection extends parallel to a portion of air flow in the air flow channel.

30. The shoe care apparatus of claim 27, wherein the air flow channel further includes a second spacing projection on a second inner surface of air flow channel, and
wherein the heat dissipation member further comprises a second heat dissipation plate arranged parallel to the second inner surface of the air flow channel, the second heat dissipation plate being in contact with the second spacing projection.

31. The shoe care apparatus of claim 30, wherein the first inner surface of the air flow channel is opposite the second inner surface of the air flow channel.

32. The shoe care apparatus of claim 30, wherein the upper body further comprises a first external cabinet configured to separate the upper space from an outside of the shoe care apparatus, and
wherein the second inner surface of the air flow channel includes an isolation projection configured to surround an edge of the second heat dissipation plate.

33. The shoe care apparatus of claim 23, wherein the air flow channel includes a suction port and a discharge port,
wherein the upper body comprises an upper bottom plate configured to separate the upper space from the accommodation space, the suction port and the discharge port being provided in the upper bottom plate, and wherein the blower is located in the air flow channel.

34. The shoe care apparatus of claim 23, wherein the upper body comprises a first external cabinet configured to separate the upper space from an outside of the shoe care apparatus, and
wherein a wall surface of the air flow channel is spaced apart from the first external cabinet.

35. The shoe care apparatus of claim 23, wherein the upper body comprises an upper bottom plate configured to separate the upper space from the accommodation space, the upper bottom plate having a main hole, and
wherein the first light comprises:
a light source;
an insertion housing inserted into the main hole, the insertion housing having a circular hole through which light from the light source is configured to pass;
a mounting housing coupled to the insertion housing, the light source being coupled to the mounting housing; and
a lens configured to close the circular hole of the insertion housing.
